(19) United States
(12) Patent Application Publication
(10) Pub. No.: US 2018/0371147 A1
(43) Pub. Date: Dec. 27, 2018

(54) AQUEOUS POLYMER DISPERSION FOR ADHESIVE COMPOUNDS

(71) Applicant: BASF SE, Ludwigshafen am Rhein (DE)

(72) Inventors: Christine TONHAUSER, Ludwigshafen (DE); Konrad ROSCHMANN, Ludwigshafen (DE); Dirk WULFF, Ludwigshafen (DE); Gemma SANDERS, Ludwigshafen (DE); Kimberly SIMANCAS, Ludwigshafen (DE); Kristina GEORGIEVA, Mannheim (DE); Ulrike LICHT, Ludwigshafen (DE); Heinrich HARRER, Ludwigshafen (DE)

(73) Assignee: BASF SE, Ludwigshafen am Rhein (DE)

(21) Appl. No.: 16/062,172

(22) PCT Filed: Dec. 14, 2016
(86) PCT No.: PCT/EP2016/080876

§ 371 Date: Jun. 14, 2018

Related U.S. Application Data
(60) Provisional application No. 62/267,294, filed on Dec. 15, 2015.

(51) Int. Cl. C08G 18/08; C08G 18/48; C08G 18/63; C08G 18/73; C08G 18/76; C08G 18/32; C08F 283/00; C09J 7/38; C09J 175/04

(52) U.S. Cl. CPC C08G 18/0866; C08G 18/4825; C08G 18/63; C08G 18/73; C08G 2170/40; C08G 18/3221; C08F 283/006; C09J 7/38; C09J 175/04; C08G 18/7621

(57) ABSTRACT

Disclose herein are aqueous polymer dispersions for pressure-sensitive adhesives, as well as processes for the preparation of the aqueous polymer dispersions, and use of the aqueous polymer dispersions.

The present invention relates to aqueous polymer dispersions for pressure-sensitive adhesives. The invention also relates to a process for their preparation and to the use of the aqueous polymer dispersions for producing adhesives.

### BACKGROUND OF THE INVENTION

The most successful adhesive raw materials, which are ever further superseding adhesives based on organic solvents, include aqueous polymer dispersions. In contrast to solvent-based adhesives, aqueous polymer dispersions permit the provision of adhesive compositions which have only a small fraction, if any, of organic solvents. Useful adhesive raw materials in this field of application are, for example, adhesives based on polyacrylates and polymers comprising urethane groups, where, in the context of the present invention, adhesive raw material is to be understood as meaning the aqueous dispersion of the binder.

Such adhesive raw materials comprise, as binder, a polymeric component which, after the drying, is responsible essentially for the mechanical and chemical properties of the coating. Such properties are a high shear strength (cohesion), a high peel strength (adhesion), a good heat stability and a good instantaneous adhesion, but also chemical and weathering resistance.

WO 2008/049932 describes radiation-curable mixtures which comprise low molecular weight ethylenically unsaturated nonaromatic compounds, and the use thereof as pressure-sensitive adhesive.

U.S. Pat. No. 3,705,164 describes aqueous polymer dispersions which are obtainable by radical polymerization of vinyl monomers in the presence of water in dispersed high molecular weight anionic polyurethanes, and the use thereof as coating material.

EP 0841357 describes polyurethane hybrid dispersions and the use thereof as coating and as adhesive, where the dispersion is obtainable by radical emulsion polymerization of olefinically unsaturated monomers in the presence of at least one polyurethane in a mixture of water and at least one water-miscible organic solvent.

U.S. Pat. No. 4,918,129 describes aqueous polymer dispersions which are obtained by polymerization of olefinically unsaturated monomers in the presence of urethane-group-having emulsifiers with a branched molecular structure, and also the use of these dispersions for producing coatings.

WO 2012/084668 describes polyurethane-polyacrylate hybrid dispersions which are obtainable by a two-stage radical polymerization of ethylenically unsaturated compounds in the presence of at least one polyurethane. Here, in a first stage, at least one ethylenically unsaturated compound, which has a glass transition temperature of at least 50° C., is at least partially radically polymerized in the presence of at least one polyurethane which is composed exclusively of aliphatic and/or cycloaliphatic isocyanates as isocyanate-group-containing structural components and has a content of at least partially neutralized acid groups below 500 mmol per kg of polyurethane, at least one redox initiator system and at least one iron compound. Then, in a second stage, at least one ethylenically unsaturated compound is radically polymerized which has a glass transition temperature of up to 20° C. Here, the weight ratio of polyurethane to the sum of the ethylenically unsaturated compounds of the first and second stages is from 50:50 to 10:90 and the temperature during the radical polymerization is not more than 85° C.

The dispersion-based pressure-sensitive adhesives known from the prior art have some serious disadvantages. For example, a high shear strength (cohesion) and heat stability coupled with simultaneous good peel force (adhesion) is not given.

### SUMMARY OF THE INVENTION

It is therefore an object of the present invention to provide novel aqueous polymer dispersions which produce adhesives with improved properties, and in particular improve shear strength (cohesion), heat resistance and peel force (adhesion). In particular, the aqueous polymer dispersions should have an optimum adhesion-cohesion balance. Further advantageous properties are a good resistance to water, chemicals and weather, as well as good coatability (uniform coating pattern) and a rapid drying.

These and other objects are achieved by the aqueous polymer dispersions described below. These aqueous polymer dispersion are obtainable by a process comprising
A) provision of an aqueous dispersion of at least one essentially uncrosslinked polyurethane PU in the form of dispersed polyurethane particles,
   where the polyurethane PU is obtainable by a polymerization of polyurethane-forming compounds PU-M, comprising at least one diol PU-M2, which has at least one poly-C₂-C₁₄-alkylene ether group which has at least one repeat unit of the formula (i)

—O—CHR^{a}—CH₂—R^{b}— (i)
where
R^{a} is hydrogen or C₁-C₁₂-alkyl,
R^{b} is a bond or C₁-C₃-alkenyl,
where R^{a} is not hydrogen if R^{b} is a bond,
and where the PU has essentially no ethylenically unsaturated double bonds and has a gel fraction of <20%;
B) radical polymerization of a monomer composition PA-M from radically polymerizable, ethylenically unsaturated compounds, comprising, as main constituent, at least one monomeric ethylenically unsaturated compound which has a solubility in water of <60 g/l at 20° C. and 1 bar, where the monomer composition has a theoretical glass transition temperature according to Fox of at most 50° C., in the aqueous dispersion of the at least one polyurethane PU, where the majority of the monomer composition PA-M is added in the course of the polymerization to the aqueous polymer dispersions of the at least one polyurethane PU.

Accordingly, the present invention relates to aqueous polymer dispersions of this type.

The invention further provides processes for preparing an aqueous polymer dispersion, comprising the steps A) and B) described here and below.

The invention further provides the use of an aqueous polymer dispersion according to the invention and/or of an aqueous polymer dispersion which has been prepared by the process according to the invention for producing adhesives, preferably as pressure-sensitive adhesive for producing sticky labels, sticky tapes, plasters, bandages and self-adhesive films.

The invention further provides pressure-sensitive adhesive articles, where at least some of the substance surface is coated with at least one aqueous polymer dispersion according to the invention and/or with at least one aqueous polymer dispersion which has been prepared by the process according to the invention.

The aqueous polymer dispersions according to the invention surprisingly exhibit excellent properties with regard to shear strength, heat resistance and peel force.

Moreover, the process according to the invention is suitable for a particularly economical production of the dispersions.

### DETAILED DESCRIPTION OF THE INVENTION

In the context of the invention, the prefix Cₙ-Cₘ indicates the number of carbon atoms which a molecule or radical designated therewith can have. The number of carbon atoms in Cₙ-Cₘ is thus in the range from n to m.

In the context of the invention, the term “C₁-C₁₂-alkyl” describes unbranched and branched saturated hydrocarbons having 1 to 12 carbon atoms, such as, for example, methyl, ethyl, n-propyl, isopropyl, n-butyl, isobutyl, tert-butyl, n-pentyl, isopentyl, neopentyl, n-hexyl, n-heptyl, n-octyl, n-nonyl, n-decyl, n-undecyl, n-dodecyl and the structural isomers thereof.

In the context of the invention, the term “C₁-C₃-alkylene” describes unbranched and branched saturated hydrocarbons having 1 to 3 carbon atoms, such as, for example, methylene, ethylene, n-propylene, isopropylene. Preferred C₁-C₃-alkylene are methylene, ethylene, n-propylene.

In the context of the invention, the term “C₁-C₂₀-alkyl esters” describes esters of unbranched and branched saturated hydrocarbons having 1 to 20 carbon atoms, for example methyl, ethyl, n-propyl, isopropyl, n-butyl, isobutyl, tert-butyl, n-pentyl, isopentyl, neopentyl, n-hexyl, n-heptyl, n-octyl, n-nonyl, n-decyl, n-undecyl, n-lauryl, n-myristyl, n-cetyl, n-stearyl, n-arachinyl esters and the structural isomers thereof.

In the context of the invention, the term “saturated aliphatic diisocyanates” refers to saturated acyclic and cyclic hydrocarbon compounds which carry two isocyanate groups. In particular, this term refers to acyclic saturated aliphatic diisocyanates. In the context of the invention, the term “saturated alicyclic diisocyanates” refers to saturated hydrocarbon compounds with at least one, e.g. 1 or 2, carbocyclic structural units, e.g. with 1 or 2 cyclohexane units which have two isocyanate groups. The same applies to diols and corresponding compounds.

In the context of the invention, the term “polar groups” describes compounds or groups which are ionic, ionizable or polar.

Examples of polar compounds are carboxylic acids, sulfonic acids, sulfonic acid esters, phosphoric acids, phosphoric acid esters, and the salts thereof. Examples of polar groups are in particular anionic groups such as carboxylate, sulfonate, sulfate, phosphonate, phosphate and the corresponding acid groups. The polar groups also include C₁-C₄-alkoxypolyethyleneoxy groups.

In the context of the invention, the term “group that is reactive towards isocyanate” describes a group which reacts with isocyanate groups to form a covalent bond. Examples thereof are hydroxy, thiol, primary amine and secondary amine.

(Meth)acrylic and similarly the designations (meth)acrylic acid and (meth)acrylate comprise both acrylic, acrylic acid and acrylate as well as methacrylic, methacrylic acid and methacrylate.

Usually, the physical properties can be determined as follows:
Particle size of the dispersion by means of dynamic light scattering (DLS) or by means of hydrodynamic radius (HDC).
Molar mass of the polymers, in particular the number-average molar mass Mn and the weight-average molar mass Mw, by means of gel permeation chromatography (GPC) or by means of mass spectrometry.
Unless stated otherwise, the molar mass given for the polymers refers in each case to the weight-average molar mass.
Glass transition temperature (Tg) by means of dynamic differential scanning calorimetry (DSC), preferably in accordance with the ASTM specification D3418-03 at a heating rate of 10° C./min.
A calculation of the glass transition temperature moreover in accordance with known methods based on tabulated values for certain monomers, such as, for example, in accordance with Fox, does not necessarily lead to different glass transition temperatures of the ranges, for example if crosslinkers are used as monomers, the influence of which on the glass transition temperature cannot be ascertained by calculation. For monomer mixtures without crosslinkers, the calculation of the glass transition temperature in accordance with Fox, however, can produce good approximation values.
Melting temperature (Tm) by means of dynamic differential scanning calorimetry (DSC).
The gel fraction can be determined, for example, by means of field flow fractionation (FFF), as defined herein. The gel fraction can likewise be determined by means of analytical ultracentrifuge (AUC), as described by W. Mächtle, G. Ley and J. Streib in Prog. Coll. Pol. Sci. 2007, 99, 144-153, with THF as solvent.

Unless stated otherwise, standards and data refer to (measurement) processes in the corresponding ASTM and IUPAC publications on the date of the patent application.

The aqueous polymer dispersions according to the invention are obtainable by a process comprising
A) provision of an aqueous polymer dispersion of at least one polyurethane PU in the form of dispersed polyurethane particles;
B) radical polymerization of a monomer composition PA-M in the aqueous polymer dispersion of the at least one polyurethane PU.

The polyurethane PU has essentially no ethylenically unsaturated bond. “Essentially no” means that the PU has less than 0.1 mol/kg, preferably less than 0.01 mol/kg, of ethylenically unsaturated bonds. Particularly preferably, the PU has no ethylenically unsaturated bonds at all.

The polyurethane PU has a gel fraction of <20%, preferably of <10%, measured using the method of field flow fractionation (FFF) defined herein. Particularly preferably, the PU has no gel fraction at all. Alternatively to the field flow fractionation (FFF), the gel content can also be determined by means of an analytical ultracentrifuge (AUC), as described by W. Mächtle, G. Ley and J. Streib in Prog. Coll. Pol. Sci. 2007, 99, 144-153, with THF as solvent.

### Field Flow Fractionation (FFF)

For samples whose molar mass M_{w} cannot be determined by means of GPC on account of significant gel fractions (=cloudy THF solution), the determination of the gel content and of the average molar mass \dot{M}_{w} takes place by means of field flow fractionation FFF. To determine the field flow fractionation FFF, the colloidal sample (7 g/l in THF) is separated by the crossflow in a narrow fractionation channel according to the hydrodynamic radius, with the eluent used usually being THF. The radius of all fractions is read off from the angle distribution of the multiangle light scattering detector, the molar mass of each fraction result from the comparison of the refractive index detector and light scattering detector, with the function do/dc=0.08 cm³/g being used for the evaluation. For the determination of the sol fractions, prefiltration is performed over 0.2 μm, and for that of the gel fractions over 5.0 μm. Missing fractions, i.e. in the case of a recovery rate <100%, could either have been retained in the prefilter (=gel bodies >5 μm) or have escaped through the separation membrane (=low molecular weight constituents with M_{w}<5 kDa). The resulting measurement values for % sol or % gel are correspondingly corrected according to their behavior during sample preparation and add up to 100%. The average molar mass \dot{M}_{w} is calculated from the formula \dot{M}_{w}=% Sol×M_{w}(sol)+% Gel×M_{w}(gel).

The following settings are used: sol fractions: flow rate: 0.7 mL/min; crossflow: 3.0 const. 5 min to 0.1 mL/min in 20 min; Focus: 133. Gel fractions: flow rate: 0.7 mL/min; crossflow: 3.0 const. 3 min to 0.1 mL/min in 15 min; Focus: 133.

The polyurethane PU is preferably essentially uncrosslinked. “Essentially uncrosslinked” means that the PU has a degree of crosslinking of less than 5%, preferably less than 2% and particularly preferably less than 1%. The degree of crosslinking is calculated as the quotient from the mole number of crosslinked and crosslinking basic building blocks and the mole number of basic building blocks present overall.

According to the invention, the polyurethane PU is obtainable by a polymerization of polyurethane-forming compounds PU-M, comprising at least one diol PU-M2, which has at least one poly-C₂-C₁₄-alkylene ether group which has at least one repeat unit of the formula (i)

—O—CHR^{a}—CH₂—R^{b}— (i)

where
R^{a} is hydrogen or C₁-C₁₂-alkyl, preferably C₁-C₁₂-alkyl, particularly preferably C₁-C₄-alkyl, very particularly preferably methyl or ethyl,
R^{b} is a bond or C₁-C₃-alkylene,
   where R^{a} is not hydrogen if R^{b} is a bond.

In the respective repeat units —O—CHR^{a}—CH₂—R^{b}— of the formula (i), the radicals R^{a} and R^{b}, independently of one another, can be identical or different, where in each case R^{a} is not hydrogen if R^{b} is a bond.

The polyurethane PU is obtainable by a polymerization of polyurethane-forming compounds, where at least one diol PU-M2 is used which has at least one poly-C₂-C₁₄-alkylene ether group which has repeat units of the formula (i).

The diol PU-M2 can have further groups in addition to the at least one poly-C₂-C₁₄-alkylene ether group, for example alkyl, alkylene, carbonate, ester and ether groups.

Preferably, the diol PU-M2 has at least 80% by weight, particularly preferably at least 90% by weight and very particularly preferably at least 95% by weight, based on the total weight of the diol, of poly-C₂-C₁₄-alkylene ether group.

Preferably, in the diol PU-M2, at least 50%, particularly preferably at least 70% and very particularly preferably at least 90% of the repeat units of the poly-C₂-C₁₄-alkylene ether groups are those of the formula (i).

For example, the PU has units which are selected from polyether diols, for example polypropylene glycol, polyethylene glycol-polypropylene glycol-copolymers and terpolymers, polybutylene glycol or polytetrahydrofuran and copolymers thereof. The functionality of the polyether diols is preferably in the range from 1.5 to 2.5 and particularly preferably in the range from 1.8 to 2.2. In particular, the functionality is 2.

Preferably, the diol PU-M2 has a molar mass in the range from 1000 to 10 000 g/mol, particularly preferably in the range from 1500 to 5000 g/mol.

Moreover, all customary polyurethane-forming monomers can be used.

Suitable isocyanate components are the di- and polyisocyanates usually used in polyurethane chemistry, for example commercially available di- and polyisocyanates carrying 4 to 30 carbon atoms, such as, for example, commercially available aliphatic, cycloaliphatic and aromatic diisocyanate and polyisocyanate compounds.

Examples of customary diisocyanates are aliphatic diisocyanates such as tetramethylene diisocyanate, pentamethylene diisocyanate, hexamethylene diisocyanate (1,6-diisocyanatohexane, HDI), octamethylene diisocyanate, decamethylene diisocyanate, dodecamethylene diisocyanate, tetradecamethylene diisocyanate, esters of lysine diisocyanate, trimethylhexane diisocyanate or tetramethylhexane diisocyanate, cycloaliphatic diisocyanates such as 1,4-, 1,3- or 1,2-diisocyanatocyclohexane, trans/trans, cis/cis and cis/trans isomers of 4,4′- or 2,4′-di(isocyanatocyclohexyl)methane (H₁₂MDI), 1-isocyanato-3,3,5-trimethyl-5-(isocyanato-methyl)cyclohexane (isophorone diisocyanate, IPDI), 2,2-bis(4-isocyanatocyclohexyl)-propane, 1,3- or 1,4-bis(isocyanatomethyl)cyclohexane or 2,4- or 2,6-diisocyanato-1-methylcyclohexane or aromatic diisocyanates such as toluene diisocyanate (TDI), methylene diphenyl isocyanate (MDI) or tetramethylxylylene diisocyanate (TMXDI), and NCO-terminated polycarbodiimides, for example NCO-terminated polycarbodiimides based on TMXDI.

Suitable polyisocyanates are also polyisocyanates having isocyanurate groups, uretdione diisocyanates, polyisocyanates having biuret groups, polyisocyanates having urethane or allophanate groups, polyisocyanates comprising oxadiazinetrione groups, uretonimine-modified polyisocyanates of straight or branched C₄-C₂₀-alkylene diisocyanates or cycloaliphatic diisocyanates having in total 6 to 20 carbon atoms or mixtures thereof.

Preference is given to
polyisocyanates of aliphatic and/or cycloaliphatic diisocyanates having isocyanurate groups, in particular the corresponding aliphatic and/or cycloaliphatic isocyanato isocyanurates, for example based on hexamethylene diisocyanate and isophorone diisocyanate;
uretdione diisocyanates with aliphatically and/or cycloaliphatically bonded isocyanate groups, preferably aliphatically and/or cycloaliphatically bonded and in particular based on hexamethylene diisocyanate or isophorone diisocyanate;
polyisocyanates having biuret groups and with cycloaliphatically or aliphatically bonded, preferably cycloaliphatically or aliphatically bonded isocyanate groups, in particular tris(6-isocyanatohexyl)biuret or mixtures thereof with its higher homologs.
Polyisocyanates having urethane and/or allophanate groups and with aliphatically or cycloaliphatically bonded, preferably aliphatically or cycloaliphatically bonded isocyanate groups, as can be obtained, for example, by reaction of excess amounts of hexamethylene diisocyanate or of isophorone diisocyanate with polyhydric alcohols such as e.g. trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof.
Polyisocyanates comprising oxadiazinetrione groups, preferably derived from hexamethylene diisocyanate or isophorone diisocyanate;
uretonimine-modified polyisocyanates.

Preferred di- and polyisocyanates are selected from diisocyanates, for example aromatic and aliphatic diisocyanate compounds having 4 to 70 carbon atoms, preferably
aromatic diisocyanates, for example methylene di(phenylisocyanate) (MDI), toluene 2,4-diisocyanate, tetramethylxylylene diisocyanate;
aliphatic acyclic saturated and unsaturated diisocyanates, for example tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, esters of lysine diisocyanate, trimethylhexane diisocyanate or tetramethylhexane diisocyanate, cycloaliphatic diisocyanates such as 1,4-, 1,3- or 1,2-diisocyanatocyclohexane, trans/trans, cis/cis and cis/trans isomers of 4,4′- or 2,4′-di(isocyanatocyclohexyl)methane, 1-isocyanato-3,3,5-trimethyl-5-(isocyanato-methyl)cyclohexane (isophorone diisocyanate), 2,2-bis(4-isocyanatocyclohexyl) propane, 1,3- and 1,4-bis(isocyanatomethyl)cyclohexane, 2,4- and 2,6-diisocyanato-1-methylcyclohexane;
aliphatic cyclic saturated and unsaturated diisocyanates, for example 1,4-, 1,3- or 1,2-diisocyanatocyclohexane, trans/trans, cis/cis and cis/trans isomers of 4,4′- or 2,4′-di(isocyanatocyclohexyl)methane, 1-isocyanato-3,3,5-trimethyl-5-(isocyanatomethyl)cyclohexane (isophorone diisocyanate), 2,2-bis(4-iso-cyanatocyclohexyl)propane, 1,3- and 1,4-bis(isocyanatomethyl)cyclohexane, 2,4- and 2,6-diisocyanato-1-methylcyclohexane
NCO-terminated polycarbodiimides, e.g. NCO-terminated polycarbodiimides based on TMXDI, for example the TMXDI dimer, trimer or tetramer;
   and from compounds which have more than 2 isocyanate groups, for example 3, 4, 5 or more isocyanate groups, preferably aromatic, aliphatic and cycloaliphatic polyisocyanate compounds having 4 to 70 carbon atoms.

Particular preference is given to diisocyanates which are preferably selected from toluene 2,4-diisocyanate (TDI), 1-isocyanato-3,5,5-trimethyl-5-isocyanatomethylcyclohexane (IPDI), tetramethylxylylene diisocyanate (TMXDI), hexamethylene diisocyanate (HDI), bis(4-isocyanatocyclohexyl)methane (HMDI) and mixtures thereof.

It is also possible to use mixtures of said diisocyanates.

The polyurethane PU is often obtainable by a polymerization of polyurethane-forming compounds PU-M, comprising:
a) at least one isocyanate component PU-M1, comprising at least one diisocyanate compound PU-M1a and
b) at least one di- or polyol component, comprising at least one diol PU-M2, as defined herein.

In particular, the polyurethane PU is obtainable by a polymerization of polyurethane-forming compounds PU-M, comprising:
a) at least one isocyanate component PU-M1, comprising:
   a1) at least one diisocyanate compound PU-M1a and
   a2) optionally at least one isocyanate compound PU-M1b, different from PU-M1a, which has more than 2 isocyanate groups per molecule,
b) at least one di- or polyol component, comprising:
   b1) at least one diol PU-M2 which has at least one poly-C₂-C₁₄-alkylene ether group which has at least one repeat unit of the formula (i)

—O—CHR^{a}—CH₂—R^{b}— (i)
where
R^{a} is hydrogen or C₁-C₁₂-alkyl, preferably hydrogen or C₁-C₄-alkyl, particularly preferably methyl or ethyl,
R^{b} is a bond or C₁-C₃-alkylene,
where R^{a} is not hydrogen if R^{b} is a bond,
b2) optionally one or more diol or polyol components PU-M3, different from PU-M2, which are selected from
   aliphatic saturated oligomeric and polymeric diol and polyol compounds PU-M3a and
   aliphatic, cycloaliphatic and aromatic low molecular weight diol compounds PU-M3b with a molar mass of less than 400 g/mol,
c) optionally at least one component PU-M4 which has at least one polar or polarizable group and at least one group that is reactive towards isocyanate,
d) optionally one or more component PU-M5 different from components a) to c).

The compound PU-M1a is selected from compounds which have 2 isocyanate groups, for example aromatic and aliphatic diisocyanate compounds having 4 to 70 carbon atoms.

Preferably, the compound PU-M1a is selected from
aromatic diisocyanates, for example methylene di(phenylisocyanate) (MDI), toluene 2,4-diisocyanate, tetramethylxylylene diisocyanate;
aliphatic acyclic saturated and unsaturated diisocyanates, for example tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, esters of lysine diisocyanate, trimethylhexane diisocyanate or tetramethylhexane diisocyanate, cycloaliphatic diisocyanates such as 1,4-, 1,3- or 1,2-diisocyanatocyclohexane, trans/trans, cis/cis and cis/trans isomers of 4,4′- or 2,4′-di(isocyanatocyclohexyl)methane, 1-isocyanato-3,3,5-trimethyl-5-(isocyanatomethyl)cyclohexane (isophorone diisocyanate), 2,2-bis(4-iso-cyanatocyclohexyl)propane, 1,3- and 1,4-bis(isocyanatomethyl)cyclohexane, 2,4- and 2,6-diisocyanato-1-methylcyclohexane;
aliphatic cyclic saturated and unsaturated diisocyanates, for example 1,4-, 1,3- or 1,2-diisocyanatocyclohexane, trans/trans, cis/cis and cis/trans isomers of 4,4′- or 2,4′-di(isocyanatocyclohexyl)methane, 1-isocyanato-3,3,5-trimethyl-5-(isocyanatomethyl)cyclohexane (isophorone diisocyanate), 2,2-bis(4-iso-cyanatocyclohexyl)propane, 1,3- and 1,4-bis(isocyanatomethyl)cyclohexane, 2,4- and 2,6-diisocyanato-1-methylcyclohexane.

Particularly preferably, the compound PU-M1a is selected from toluene 2,4-diisocyanate (TDI), 1-isocyanato-3,5,5-trimethyl-5-isocyanatomethylcyclohexane (isophorone diisocyanate, IPDI), tetramethylxylylene diisocyanate (TMXDI), hexamethylene diisocyanate (HDI), bis(4-isocyanatocyclohexyl)methane (HMDI) and mixtures thereof.

The compound PU-M1b is selected from compounds which have more than 2 isocyanate groups, for example 3, 4, 5 or more isocyanate groups, for example aromatic, aliphatic and cycloaliphatic polyisocyanate compounds having 4 to 70 carbon atoms. Suitable polyisocyanate compounds are, for example, polyisocyanates having isocyanurate groups, uretdione diisocyanates, polyisocyanates having biuret groups, polyisocyanates having urethane or allophanate groups, polyisocyanates comprising oxadiazinetrione groups, uretonimine-modified polyisocyanates of straight or branched C₄-C₇₀-alkylene diisocyanates or cycloaliphatic diisocyanates having in total 6 to 20 carbon atoms or mixtures thereof.

Preferably, the compound PU-M1b is selected from aromatic, aliphatic and cycloaliphatic tri-, tetra-, penta- or polyisocyanate compounds having 4 to 30 carbon atoms.

Preferably, the isocyanate component PU-M1 comprises at least 70% by weight, particularly preferably at least 80% by weight and in particular at least 90% by weight, based on the total mass of the compounds PU-M1, of compounds PU-M1a.

In one embodiment, the isocyanate component PU-M1 comprises exclusively compounds PU-M1a.

The diol PU-M2 is selected from diols which have at least one poly-C₂-C₁₄-alkylene ether group which has at least one repeat unit of the formula (i)

—O—CHR^{a}—CH₂—R^{b}— (i)

where
R^{a} is hydrogen or C₁-C₁₂-alkyl, preferably C₁-C₁₂-alkyl, particularly preferably C₁-C₄-alkyl, very particularly preferably methyl or ethyl,
R^{b} is a bond or C₁-C₃-alkylene,
   where R^{a} is not hydrogen if R^{b} is a bond.

Possible diols PU-M2 of the formula (i) are, for example, polypropylene oxide, polybutylene oxide, polytetrahydrofuran, and copolymers thereof, as well as copolymers which comprise polypropylene oxide, polybutylene oxide or polytetrahydrofuran repeat units.

It is clear to the person skilled in the art that the diols PU-M2 do not comprise pure polyethylene glycol (i.e. R^{a}=hydrogen and R^{b}=a bond).

Here, the radicals R^{a} and R^{b}, independently of one another, can be identical or different.

Preferably, in the diol PU-M2, in the repeat units of the formula (i), R^{a}, independently of the others, is C₁-C₁₂-alkyl, particularly preferably C₁-C₄-alkyl, very particularly preferably methyl or ethyl.

Preferably, in the diol PU-M2, in the repeat units of the formula (i), R^{b}, independently of the others, is a bond or C₁-C₃-alkylene.

In a specifically preferred embodiment, R^{a} is not hydrogen.

The diol PU-M2 can have further groups in addition to the at least one poly-C₂-C₁₄-alkylene ether group, for example alkyl, alkylene, carbonate, ester and ether groups.

For example, the diol PU-M2 has at least one unit of the formula (ii)

—R^{c}—O—CHR^{d}—CH₂—R^{e}—R^{f}— (ii)

where
R^{c} is a bond or is —C(═O)—, or —O—C(═O)—,
R^{d} is hydrogen or C₁-C₁₂-alkyl, preferably C₁-C₁₂-alkyl, particularly preferably C₁-C₄-alkyl,
R^{e} is a bond or is C₁-C₁₁-alkylene, in particular is a bond or is C₁-C₃-alkylene,
R^{f} is a bond or is —C(═O)—, —O—C(═O)— or —C(═O)—O—,
   with the proviso that R^{e} and R^{f} are not both a bond.

Preferably, the diol PU-M2 has at least 80% by weight, particularly preferably at least 90% by weight and very particularly preferably at least 95% by weight, based on the total weight of the diol, of poly-C₂-C₁₄-alkylene ether groups.

Preferably, the diol PU-M2, at least 50%, particularly preferably at least 70% and very particularly preferably at least 90%, of the poly-C₂-C₁₄-alkylene ether groups are those of the formula (i).

The diol PU-M2 is preferably selected from polyether diols, for example those which are obtainable by polymerization of propylene oxide and/or butylene oxide, optionally with further monomers such as, for example, ethylene oxide, tetrahydrofuran, or epichlorohydrin, for example in the presence of BF₃, or by addition of these compounds, optionally in a mixture or successively, onto starting components with reactive hydrogen atoms, such as alcohols or amines, water, ethylene glycol, propane-1,2-diol, propane-1,3-diol, 2,2-bis(4-hydroxydiphenyl)propane and aniline.

Preference is given to polypropylene glycol and polyethylene glycol-polypropylene glycol copolymers and terpolymers, polybutylene glycol, polytetrahydrofuran and copolymers thereof.

In a preferred embodiment, the diol PU-M2 is selected from polyetherdiols of the formula (iii),

H—(O—CHR^{a}—CH₂—R^{b})ₙ—OH (iii)

where
R^{a} and R^{b} are as defined herein and
n is a natural number in the range from 5 to 500, and preferably in the range from 10 to 300, particularly preferably from 15 to 200.

Possible diols PU-M2 of the formula (iii) are then, for example, polypropylene oxide, polypropylene oxide co-polyethylene oxide, polybutylene oxide and polytetrahydrofuran.

In one embodiment, in the diols of the formula (iii) R^{a} is C₁-C₁₂-alkyl, preferably C₁-C₄-alkyl, in particular methyl or ethyl. Preferably, the diol PU-M2 is then polypropylene glycol or polybutylene glycol.

Preferably, the diol PU-M2 has a molar mass in the range from 1000 to 10 000 g/mol, particularly preferably in the range from 1500 to 5000 g/mol.

The component PU-M3 is selected from diol or polyol compounds different from the compounds PU-M2. These are selected from PU-M3a and PU-M3b.

The compounds PU-M3a are selected from aliphatic saturated oligomeric and polymeric diol and polyol compounds different from the compounds PU-M2. Suitable compounds are, for example, polyetherdiols, e.g. polyethylene oxide, polyetherpolyols, for example branched polyethylene oxides, polyester diols, polyester polyols, polycarbonate diols and polycarbonate polyols.

The compound PU-M3a is preferably selected from diol compounds and polyol compounds different from the compounds PU-M2, preferably having a weight-average molar mass in the range from 100 to 20 000 g/mol, in particular in the range from 400 to 15 000 g/mol.

The polyetherdiols and polyetherpolyols are customary components. They are obtainable in particular by polymerization of ethylene oxide, styrene oxide or epichlorohydrin with themselves, e.g. in the presence of BF₃ or by the addition of these compounds, optionally in a mixture or successively, onto starting components with reactive hydrogen atoms, such as alcohols or amines, for example water, ethylene glycol, propane-1,2-diol, propane-1,3-diol, 2,2-bis(4-hydroxydiphenyl)propane or aniline. Particular preference is given to polyethylene glycol and other polyetherdiols or polyetherpolyols different from the compounds M2 and with a molecular weight of from 500 to 5000 g/mol, and especially 1000 to 4500 g/mol. Very particular preference is given to polyethylene glycol.

The polyester diols and polyester polyols are customary components which are known e.g. from Ullmanns Encyklopädie der technischen Chemie [Ullmann's Encyclopedia of Industrial Chemistry], 4th edition, volume 19, pp. 62 to 65. Preference is given to using polyester polyols which are obtained by reaction of dihydric alcohols with dibasic carboxylic acids. Instead of the free polycarboxylic acids, it is also possible to use the corresponding polycarboxylic anhydrides or corresponding polycarboxylic acid esters of low alcohols or mixtures thereof for preparing the polyester polyols.

The polycarboxylic acids may be aliphatic, cycloaliphatic, araliphatic, aromatic or heterocyclic and be optionally substituted, e.g. by halogen atoms, and/or unsaturated. Examples thereof that may be mentioned are: oxalic acid, malonic acid, maleic acid, maleic anhydride, fumaric acid, succinic acid, glutaric acid, glutaric anhydride, adipic acid, pimelic acid, suberic acid, azelaic acid, sebacic acid, undecanedicarboxylic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, dimeric fatty acids. Preference is given to dicarboxylic acids of the general formula HOOC—(CH₂)_{y}—COOH, where y is a number from 1 to 20, preferably an even number from 2 to 20, e.g. succinic acid, adipic acid, dodecanedicarboxylic acid and sebacic acid.

Suitable polyhydric alcohols are e.g. ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, also diethylene glycol, triethylene glycol, tetraethylene glycol, polyethylene glycol, dipropylene glycol, polypropylene glycol, dibutylene glycol and polybutylene glycols. Preference is given to neopentyl glycol and alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol and dodecane-1,12-diol. Furthermore of suitability are also polycarbonate diols, as can be obtained e.g. by the reaction of phosgene with an excess of low molecular weight alcohols specified as structural components for the polyester polyols. Also of suitability are polyester diols based on lactone, which are homo- or copolymers of lactones, preferably addition products of lactones onto suitable difunctional starting molecules that have terminal hydroxyl groups. Suitable lactones are preferably those which are derived from hydroxycarboxylic acids of the general formula HO—(CH₂)_{z}—COOH, where z is a number from 1 to 20, preferably an uneven number from 3 to 19, e.g. ε-caprolactone, β-propiolactone, γ-butyrolactone, valerolactone and methyl-ε-caprolactone, and mixtures thereof. Suitable starter components are e.g. the low molecular weight dihydric alcohols specified above as structural component for the polyester polyols. The corresponding polymers of ε-caprolactone are particularly preferred. Low polyester diols or polyetherdiols can also be used as starters for preparing the lactone polymers. Instead of the polymers of lactones, it is also possible to use the corresponding, chemically equivalent polycondensates of the hydroxycarboxylic acids corresponding to the lactones. Likewise of suitability as monomers are also polyetherdiols. They are obtainable in particular by polymerization of ethylene oxide, propylene oxide, butylene oxide, tetrahydrofuran, styrene oxide or epichlorohydrin.

Preferably, the component PU-M3a is selected from aliphatic polyetherdiols and -polyols and aliphatic polyester diols and -polyols, in particular from aliphatic polyetherdiols selected from polyethylene oxide, polytetrahydrofuran, and copolymers thereof, and aliphatic polyester diols and polyols which are composed of at least one C₃-C₁₂-alkanedicarboxylic acid and at least one C₃-C₁₀-alkanediol.

The compounds PU-M3b are selected from aliphatic, cycloaliphatic and aromatic low molecular weight diol compounds PU-M3b with a molar mass of less than 400 g/mol.

Preferably, the compounds PU-M3b are selected from
aliphatic unbranched and branched diol compounds having 2 to 20 carbon atoms, for example ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, hydroxypivalic acid neopentyl glycol ester, 1,2-, 1,3- and 1,4-butanediol, 1,6-hexanediol, 1,10-decanediol, 2-ethyl-1,3-hexanediol, 2,4-diethyloctane-1,3-diol, 1,1-, 1,2-, 1,3- and 1,4-cyclohexanedimethanol, 1,2-, 1,3- or 1,4-cyclohexanediol,
cyclic aliphatic diol compounds having 3 to 14 carbon atoms, for example tetramethylcyclobutanediol, 1,2-, 1,3- and 1,4-cyclohexanediol, cyclooctanediol, norbornanediol, pinanediol, decalindiol, 2,2-bis(4-hydroxycyclohexyl)propane, bis(4-hydroxycyclohexane)isopropylidene,
aromatic diol compounds having 6 to 14 carbon atoms, for example hydroquinone, bisphenol A, bisphenol F, bisphenol B, bisphenol S.

Moreover, suitable components A3b are the aliphatic and cycloaliphatic diols specified in connection with the polyester component.

Preference is given to unbranched diols having 2 to 12 carbon atoms and an even number of carbon atoms, and also 1,4-butanediol, 1,5-pentanediol and neopentyl glycol.

Particular preference is given to 1,4-butanediol, 1,5-pentanediol and neopentyl glycol.

The compound PU-M4 is selected from the compounds which have at least one polar group and at least one group that is reactive towards isocyanate.

Such compounds are illustrated for example by the general formula

RG-R*-PG

where
RG is at least one group that is reactive towards isocyanate,
R* is an aliphatic, cycloaliphatic or aromatic radical comprising 1 to 20 carbon atoms, and
PG is at least one polar group.

Examples of RG are hydroxy, thiol, primary amine and secondary amine. Preferably, RG is hydroxy and primary amine, particularly preferably hydroxy.

Examples of R* are aliphatic and cyclic, saturated and unsaturated hydrocarbons having 1 to 20 carbon atoms and unsubstituted and substituted aromatic radicals having 6 to 20 carbon atoms, preferably aliphatic and cyclic, saturated and unsaturated hydrocarbons having 1 to 12 carbon atoms.

Examples of PG are acid groups in the acid or salt form, for example carboxylic acids, sulfuric acid, sulfuric acid half-ester, phosphoric acids, sulfonic acids, phosphoric acid half-esters, phosphonic acids, and the salts thereof.

The acid groups can be present in their anionic forms and then have a counterion. Examples of counterions are alkali metal and alkaline earth metal ions, for example Li⁺, Na⁺, K⁺, Cs⁺, Mg²⁺, Ca²⁺ or Ba²⁺. Furthermore, counterions which may be present are the ammonium ions derived from ammonia or amines, in particular tertiary amines, or quaternary ammonium ions, such as, for example, ammonium, methylammonium, dimethylammonium, trimethylammonium, ethylammonium, diethylammonium, triethylammonium, tributylammonium, diisopropylethylammonium, benzyldimethylammonium, monoethanolammonium, diethanolammonium, triethanolammonium, hydroxyethyldimethylammonium, hydroxyethyldiethylammonium, monopropanolammonium, dipropanolammonium, tripropanolammonium, piperidinium, piperazinium, N,N′-dimethylpiperazinium, morpholinium, pyridinium, tetramethylammonium, triethylmethylammonium, 2-hydroxyethyltrimethylammonium, bis(2-hydroxyethyl)dimethylammonium or tris(2-hydroxyethyl)methylammonium.

Further examples of polar groups PG are poly-C₂-C₃-alkylene oxide groups, e.g. polyethylene oxide groups, poly(ethylene oxide-co-propylene oxide) groups and polypropylene oxide groups. These are preferably terminally capped at one end. Suitable end groups are, for example, C₁-C₁₀-alkyl, preferably C₁-C₄-alkyl or the corresponding methoxyalkyls. Examples of compounds in the formula RG-R*-PG in which PG is a terminally capped poly-C₂-C₃-alkylene oxide group are methoxy(polyethylene glycol), ethoxy(polyethylene glycol) and butoxy(polyethylene glycol), in particular those with a molecular weight in the range from 200 to 3000 g/mol (number average). Further examples are dihydroxy compounds such as MPEG monoethers based on trimethylolpropane, e.g. the Ymer™ N120 from Perstorp, or ethoxylated polyether-1,3-diols, e.g. the Tegomer® D3403 from Evonik Industries.

Preferably, the compounds PU-M4 are selected from hydroxycarboxylic acids, amino-carboxylic acids and aminosulfonic acids, in particular from those having 3 to 10 carbon atoms, and salts thereof. The compounds PU-M4 are particularly preferably selected from dihydroxycarboxylic acids, diaminocarboxylic acids and diaminosulfonic acids and salts thereof.

Examples of aliphatic dihydroxycarboxylic acids are 2,3-dihydroxypropanoic acid, 2,2-dimethylolpropionic acid, 2,2-dimethylolbutyric acid and 2,2-dimethylolpentanoic acid, their structural isomers and the salts thereof. Examples of aliphatic diaminocarboxylic acids are 2-aminoethyl-2-aminoethanecarboxylic acid, their structural isomers and the salts thereof. Examples of aliphatic diaminosulfonic acids are 2-aminoethyl-2-aminoethanesulfonic acid, their structural isomers and the salts thereof.

The compound PU-M4 is particularly preferably selected from dimethylolpropionic acid, 2,2-dimethylolbutyric acid, 2-aminoethyl-2-aminoethanesulfonic acid, 2-aminoethyl-2-aminoethanecarboxylic acid and the salts thereof.

Preference is given in each case to the alkali metal salts, for example the sodium and potassium salts, the ammonium salts and the triethylammonium salts.

The compound PU-M5 is selected from compounds different from the compounds PU-M1, PU-M2, PU-M3 and PU-M4.

The compound PU-M5 is preferably selected from compounds which have at least one group that is reactive towards isocyanate and are different from the compounds PU-M2, PU-M3, and PU-M4.

Possible compounds PU-M5 are diamines, for example hydrazine and diamines, such as, for example, ethylenediamine, propylenediamine, hexamethylenediamine and isophoronediamine.

Usually, the polyurethane-forming compounds PU-M comprise, based on the total amount of the compounds PU-M, 5 to 40% by weight, preferably 10 to 25% by weight, of at least one isocyanate component PU-M1.

Usually, the polyurethane-forming compounds PU-M comprise, based on the total mass of the compounds PU-M2, PU-M3, PU-M4 and PU-M5, 45 to 100% by weight, preferably 70 to 99.5% by weight, very particularly preferably 78 to 98% by weight, of at least one diol component PU-M2.

Usually, the polyurethane-forming compounds PU-M comprise, based on the total mass of the compounds PU-M2, PU-M3, PU-M4 and PU-M5, 0 to 20% by weight, preferably 0 to 15% by weight, very particularly preferably 0 to 10% by weight, of at least one diol or polyol component PU-M3.

Usually, the polyurethane-forming compounds PU-M comprise, based on the total mass of the compounds PU-M2, PU-M3, PU-M4 and PU-M5, 0 to 15% by weight, preferably 0.5 to 10% by weight, very particularly preferably 2 to 10% by weight, of at least one component PU-M4,

Usually, the polyurethane-forming compounds PU-M comprise, based on the total mass of the compounds PU-M2, PU-M3, PU-M4 and PU-M5, 0 to 10% by weight, preferably 0 to 5% by weight, very particularly preferably 0 to 2% by weight, of compounds PU-M5 different from the components PU-M1, PU-M2, PU-M3, PU-M4.

Preferably, the polyurethane-forming compounds PU-M comprise:
a) 5 to 40% by weight, preferably 10 to 25% by weight, of at least one isocyanate component PU-M1, based on the total mass of the compounds PU-M,
b1) 45 to 100% by weight, preferably 70 to 99.5% by weight, based on the total mass of the compounds PU-M2, PU-M3, PU-M4 and PU-M5, of at least one diol component PU-M2,
b2) 0 to 20% by weight, preferably 0 to 15% by weight, based on the total mass of the compounds PU-M2, PU-M3, PU-M4 and PU-M5, of at least one diol or polyol component PU-M3,
c) 0 to 15% by weight, preferably 0.5 to 10% by weight, based on the total mass of the compounds PU-M2, PU-M3, PU-M4, PU-M5, of at least one component PU-M4,
d) 0 to 10% by weight, preferably 0 to 5% by weight, based on the sum of the compounds PU-M2, PU-M3, PU-M4, PU-M5, of compounds PU-M5 different from the components a) to c).

The polyurethane PU preferably has less than 2% by weight, based on the total weight of the polyurethane, and preferably less than 1% by weight and particularly preferably less than 0.5% by weight of urea groups.

The polyurethane PU preferably has less than 0.1 mol/kg, preferably less than 0.05 mol/kg of ethylenically unsaturated bonds.

The polyurethane PU preferably has a weight-average molar mass (Mw) in the range from 10 000 to 500 000 g/mol, preferably in the range from 15 000 to 100 000 g/mol.

The molar mass is usually determined by means of gel permeation chromatography (GPC).

The polyurethane PU is present in the form of dispersed polyurethane particles. These usually have a volume-average diameter of from 30 to 500 nm, preferably from 50 to 150 nm. The volume-average diameter is usually determined by means of light transmission (LT %) and hydrodynamic radius (HDC).

The monomer composition PA-M comprises radically polymerizable, ethylenically unsaturated compounds, for example compounds which have precisely one ethylenically unsaturated C═C-double bond or precisely 2 conjugated ethylenically unsaturated double bonds. Possible compounds are selected from C₁-C₂₀-alkyl acrylates, C₁-C₂₀-alkyl methacrylates, vinylesters of C₁-C₂₀-carboxylic acids, vinylaromatic compounds having up to 20 carbon atoms, ethylenically unsaturated nitriles, vinyl halides, vinyl ethers of C₁-C₁₀-alcohols, aliphatic C₂-C₈-alkenes having 1 or 2 double bonds or mixtures of these monomers.

The monomer composition PA-M has a theoretical glass transition temperature according to Fox of at most +50° C., preferably of at most +30° C. Preferably, the monomer composition PA-M has a theoretical glass transition temperature according to Fox of at least −80° C., preferably of at least −50° C.

The theoretical glass transition temperature according to Fox is calculated according to the Fox equation as follows

1/Tg=xA/TgA+xB/TgB+xC/TgC+ . . . .

Tg: calculated glass transition temperature of the copolymer
TgA: glass transition temperature of the homopolymer of monomer A
TgB, TgC: Tg corresponding to monomers B, C, etc.
xA: mass fraction of monomer A, (mass of monomer A)/(total mass of copolymer),
xB, xC corresponding to monomers B, C etc.

The monomer composition PA-M comprises, as main component, at least one radically polymerizable ethylenically unsaturated compound which has a solubility in water of <60° C. g/l at 20° C. and 1 bar. Preferably, this at least one compound has precisely one ethylenically unsaturated C═C double bond or precisely 2 conjugated ethylenically unsaturated double bonds.

Possible compounds are selected from C₁-C₂₀-alkyl acrylates, C₁-C₂₀-alkyl methacrylates, vinylesters of C₁-C₂₀-carboxylic acids, vinylaromatic compounds having up to 20 carbon atoms, vinyl halides, vinyl ethers of C₁-C₁₀-alcohols, aliphatic C₂-C₈-alkenes with 1 or 2 double bonds or mixtures of these monomers.

C₁-C₂₀-Alkyl acrylates and C₁-C₂₀-alkyl methacrylates are, for example, (meth)acrylic acid alkyl esters with a C₁-C₁₀-alkyl radical, such as methyl methacrylate, methyl acrylate, n-butyl acrylate, ethyl acrylate and 2-ethylhexyl acrylate and in particular also mixtures of the (meth)acrylic acid alkyl esters.

Vinylesters of C₁-C₂₀-carboxylic acids are, for example, vinyl laurate, vinyl stearate, vinyl propionate, versatic acid vinylester and vinyl acetate.

Vinylaromatic compounds are, for example, vinyltoluene, 2-methylstyrene, 4-methylstyrene, 2-butylstyrene, 4-n-butylstyrene, 4-n-decylstyrene and preferably styrene.

Vinyl halides are, for example, ethylenically unsaturated compounds substituted with chlorine, fluorine or bromine, preferably vinyl chloride and vinylidene chloride.

Vinyl ethers are, for example, vinyl methyl ether, vinyl isobutyl ether and preferably vinyl ethers of C₁-C₄-alcohols.

Aliphatic C₂-C₈-alkenes having 1 or 2 double bonds are, for example, butadiene, isoprene and chloroprene, ethylene and propylene.

Preferably, the monomer composition PA-M comprises the following components:
a) 30 to 100% by weight, based on the total mass of the monomer composition PA-M, of at least one monomer PA-M1;
b) 0 to 70% by weight, based on the total mass of the monomer composition PA-M, of at least one monomer PA-M2, which is selected from vinylaromatic compounds, vinyl esters of saturated, branched and unbranched C₁-C₁₂-carboxylic acids and diunsaturated, branched and unbranched C₄-C₈-alkenes
c) 0 to 20% by weight, based on the total mass of the monomer composition PA-M, of at least one radically polymerizable ethylenically unsaturated monomer PA-M3 different from PA-M1 and PA-M2.

Preferably, the monomer composition PA-M comprises at least 30% by weight, particularly preferably at least 50% by weight and very particularly preferably at least 70% by weight, based on the total weight of PA-M, of at least one monomer PA-M1, which is selected from C₁-C₂₀-alkyl esters of acrylic acid, C₁-C₂₀-alkyl esters of methacrylic acid and mixtures thereof.

Examples of (meth)acrylic acid alkyl esters are: (meth)acrylic acid methyl ester, (meth)acrylic acid ethyl ester, (meth)acrylic acid n-propyl ester, (meth)acrylic acid n-butyl ester, (meth)acrylic acid isobutyl ester, (meth)acrylic acid sec-butyl ester, (meth)acrylic acid tert-butyl ester, (meth)acrylic acid n-pentyl ester, (meth)acrylic acid isopentyl ester, (meth)acrylic acid 2-methylbutyl ester, (meth)acrylic acid amyl ester, (meth)acrylic acid n-hexyl ester, (meth)acrylic acid 2-ethylbutyl ester, (meth)acrylic acid pentyl ester, (meth)acrylic acid n-heptyl ester, (meth)acrylic acid n-octyl ester, (meth)acrylic acid 2-ethylhexyl ester, (meth)acrylic acid 2-propylheptyl ester, (meth)acrylic acid n-decyl ester, (meth)acrylic acid undecyl ester and (meth)acrylic acid n-dodecyl ester.

Preferred monomers PA-M1 are the C₁-C₁₀-alkyl acrylates and C₁-C₁₀-alkyl methacrylates, in particular C₁-C₈-alkyl acrylates and C₁-C₈-alkyl methacrylates, where the acrylates and mixtures of acrylates with methacrylates are in each case particularly preferred. Very particular preference is given to methyl acrylate, ethyl acrylate, n-butyl acrylate, n-hexyl acrylate, octyl acrylate, 2-ethylhexyl acrylate and mixtures of these monomers, and also mixtures of these monomers with methyl methacrylate.

In one embodiment, the monomer composition PA-M comprises exclusively monomers PA-M1.

In another embodiment, the monomer composition PA-M comprises, besides the monomers PA-M1, at least one further monomer PA-M2, which is selected from vinylaromatic compounds, vinyl esters of saturated, branched and unbranched C₁-C₁₂-carboxylic acids and diunsaturated, branched and unbranched C₄-C₈-alkenes.

Preferred monomers M2 are the aforementioned, in particular vinylaromatic compounds, preferably vinyltoluene, 2-methylstyrene, 4-methylstyrene, 2-butylstyrene, 4-n-butylstyrene, 4-n-decylstyrene. Particular preference is given to styrene.

Preferably, the monomer composition PA-M comprises at least 0 to 70% by weight, particularly preferably 0 to 50% by weight and very particularly preferably 0 to 30% by weight, based on the total weight of PA-M, of at least one monomer PA-M2.

In a particular embodiment, the monomer composition PA-M consists exclusively of monomers which are selected from PA-M1 and PA-M2.

The monomer composition can comprise further monomers PA-M3 different from the monomers PA-M1 and PA-M2. Possible monomers PA-M3 can be, for example, monomers with carboxylic acid, sulfonic acid, phosphoric acid half-ester or phosphonic acid groups, for example acrylic acid, methacrylic acid, itaconic acid, maleic acid or fumaric acid, monomers comprising hydroxyl groups, for example C₁-C₁₀-hydroxyalkyl(meth)acrylates, (meth)acrylamide and monomers comprising ureido groups, such as ureido(meth)acrylates, monomers with phenyloxyethyl glycol mono(meth)acrylate, glycidyl acrylate, glycidyl methacrylate, and amino(meth)acrylates such as 2-aminoethyl (meth)acrylate.

The theoretical glass transition temperature of the polymer which is composed of the monomer composition PA-M is preferably in the range from −80 to +50° C., particularly preferably in the range from −50 to +30° C.

The polymerization of the monomer composition PA-M is usually carried out in the presence of a polymerization initiator.

Suitable polymerization initiators are all customary initiators known to the person skilled in the art. If the polymerization is carried out at elevated temperatures, then the sole use of a purely thermally disintegrating initiator, e.g. based on a peroxide or azo compound, which has an adequate disintegration rate at the desired reaction temperature suffices. Examples of such compounds are those specified herein as compounds (I1). However, should the polymerization take place at lower temperatures, a redox initiator system (I) consisting of an oxidizable (I1) and a reducing component (I2) is usually used.

Optionally, in addition to the polymerization initiator or the redox initiator system (I) it is possible to add compounds which comprise at least one transition metal and catalyze the disintegration of the initiator or of the initiator system. Examples thereof include iron complexes such as Dissolvine® E-FE-6 or E-FE-13 from AkzoNobel.

In the context of the present invention, suitable polymerization initiators are in particular redox initiator systems (I) of an oxidizing (I1) and a reducing component (I2) which are able to trigger a radical emulsion polymerization in aqueous media. They are generally used in amounts of from 0.1 to 10% by weight, preferably from 0.2 to 4% by weight, based on the total amount of the monomer composition.

Customary compounds (I1) are inorganic peroxides, for example sodium peroxidisulfate, ammonium peroxidisulfate and hydrogen peroxide, organic peroxides, for example dibenzoyl peroxide and tert-butyl hydroperoxide, and azo compounds, for example azo isobutyrodinitrile.

Preferred compounds are dibenzoyl peroxide and tert-butyl hydroperoxide.

Further examples include peroxodisulfates, for example potassium, sodium or ammonium peroxodisulfates, peroxides, for example sodium peroxide or potassium peroxide, perborates, for example ammonium, sodium or potassium perborates, mono-persulfates, for example ammonium, sodium or potassium hydrogenmonopersulfates, salts of peroxycarboxylic acids, for example ammonium, sodium, potassium or magnesium monoperoxyphthalate, tert-butyl hydroperoxide, tert-amyl hydroperoxide, cumyl hydroperoxide, peracetic acid, perbenzoic acid, monoperphthalic acid or meta-chloroperbenzoic acid, and also ketoneperoxides, dialkyl peroxides, diacyl peroxides or mixed acyl-alkyl peroxides. Examples of diacyl peroxides are dibenzoyl peroxide and diacetyl peroxide. Examples of dialkyl peroxides are di-tert-butyl peroxide, dicumyl peroxide, bis(α,α-dimethylbenzyl)peroxide and diethyl peroxide. An example of mixed acyl-alkyl peroxides is tert-butyl perbenzoate. Ketoneperoxides are, for example, acetone peroxide, butanone peroxide and 1,1′-peroxybiscyclohexanol. Mention may also be made, by way of example, of 1,2,4-trioxolane or 9,10-dihydro-9,10-epidioxidoanthracene.

Reducing coinitiators (I2) are preferably hydroxymethanesulfinic acid, acetone bisulfite, isoascorbic acid and ascorbic acid, and in each case their derivatives and salts, preferably the sodium salts, particular preference being given to using ascorbic acid, sodium erythorbate and the sodium salt of hydroxymethanesulfinic acid. The latter is obtainable for example as Rongalit C from BASF or as Bruggolite SFS from Bruggemann.

In another embodiment, the polymerization of the monomer composition PA-M is carried out without a polymerization initiator. In this case, the polymerization can be initiated for example by radiation or by thermal energy.

The weight ratio of the polyurethane PU to the polymerized monomers PA-M is preferably in the range from 5:95 to 95:5, in particular in the range from 30:70 to 70:30.

In the polymer dispersion according to the invention, the polymer particles typically have an average particle size, z average measured by means of dynamic light scattering, in the range from 0.01 to 2.0 μm, preferably from 0.02 to 0.4 μm. Preferably, the average particle size is less than 2.0 μm, preferably less than 0.4 μm.

The aqueous polymer dispersion according to the invention generally has a solids content in the range from 10 to 75%, preferably in the range from 20 to 65% and particularly preferably in the range from 25 to 55%.

The invention further provides a process for preparing an aqueous polymer dispersion according to the invention, comprising the steps A) and B).

Preferably, the step A), the provision of an aqueous polymer dispersion of at least one polyurethane PU in the form of dispersed polyurethane particles, which is as defined above, takes place such that
A1) firstly a monomer composition comprising polyurethane-forming compounds PU-M is polymerized in the presence of a solvent in a polyaddition,
A2) and then the polyurethane is dispersed in water.

The preparation of the polyurethane takes place by methods known to the person skilled in the art.

The preparation can for example take place in such a way that the isocyanate component PU-M1 is reacted with the components PU-M2, PU-M3, PU-M4 and optionally PU-M5, where the reactive groups of the components PU-M2, PU-M3, PU-M4 and optionally PU-M5 react fully with the isocyanate groups of the component PU-M1. The components PU-M2, PU-M3, PU-M4 and optionally PU-M5 are typically used here in an amount which corresponds approximately to the required stoichiometry and the desired mass fractions. In particular, the isocyanate component PU-M1 and the components PU-M2, PU-M3, PU-M4 and optionally PU-M5 are used in an amount such that the molar ratio of the isocyanate groups in PU-M1 to the total amount of the functional groups in the components PU-M2, PU-M3, PU-M4 and optionally PU-M5, which react with the isocyanate groups to form covalent bonds, is in the range from 1:1.1 to 1.1:1. In particular, the molar ratio of isocyanate groups in PU-M1 to the total amount of the functional groups in the components PU-M2, PU-M3, PU-M4 and optionally PU-M5 is at least 1:1 and is specifically in the range from 1:1 to 1.05:1.

The preparation is generally carried out such that at least some, e.g. at least 75%, in particular at least 90% and specifically the total amount of the components PU-M2, PU-M3, PU-M4 and optionally PU-M5, is initially introduced and the component PU-M1 is added thereto. The addition of the component PU-M1 can take place under reaction conditions. Preferably, however, the component PU-M1 is added first and then the reaction conditions are established at which the reaction of the isocyanate groups with the reactive functional groups of the components PU-M2, PU-M3, PU-M4 and optionally PU-M5 takes place.

The reaction of the component PU-M1 with the components PU-M2, PU-M3, PU-M4 and optionally PU-M5 generally takes place at temperatures in the range from 20 to 180° C., preferably in the range from 40 to 100° C., particularly preferably in the range from 50 to 90° C. During the reaction, the temperature can remain the same or be increased continuously or in stages.

The polyaddition of the compounds PU-M can take place at subatmospheric pressure, superatmospheric pressure or atmospheric pressure. In general, the reaction takes place under atmospheric pressure.

The reaction is generally carried out until the NCO value has reached the theoretical conversion value to at least 95%, preferably to at least 97% and particularly preferably to at least 98%. Preferably, the reaction takes place until the content of isocyanate groups in the reaction mixture does not exceed a value of 1% by weight, in particular 0.5% by weight. The reaction times required for this are usually in the range from 3 to 20 hours, in particular in the range from 5 to 12 hours, depending on the selected reaction temperature. Preferably, the reaction takes place with thorough mixing of the reaction mixture, for example with stirring and/or circulation by pumping.

The rate of the reaction is preferably increased by adding at least one suitable catalyst. Such catalysts are known in the literature, for example from G. Oertel (ed.), Polyurethane [Polyurethanes], 3rd edition, 1993, Carl Hanser Verlag, Munich—Vienna, pages 104 to 110, chapter 3.4.1. “Katalysatoren [Catalysts]”.

Suitable catalysts are organic amines, in particular tertiary aliphatic, cycloaliphatic or aromatic amines, Brønsted acids and/or Lewis acidic organic metal compounds, with the latter being preferred. Also of suitability are mixtures of the aforementioned catalysts.

Examples of Lewis-acidic organic metal compounds are
tin compounds, in particular tin(II) salts of organic carboxylic acids, e.g. tin(II) diacetate, tin(II) dioctoate, tin(II) bis(ethylhexanoate) and tin(II) dilaurate and the dialkyltin(IV) salts of organic carboxylic acids, e.g. dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate;
zinc salts of organic carboxylic acids, e.g. zinc(II) diacetate, zinc(II) dioctoate, zinc(II) bis(ethylhexanoate), zinc(II) neodecanoate (zinc(II) bis(7,7-dimethyloctanoate) and tin(II) dilaurate;
bismuth compounds, e.g. bismuth carboxylates, in particular of carboxylates which have at least six carbon atoms, e.g. bismuth octoates, ethylhexanoates, neodecanoates or pivalates; for example K-KAT 348, XC-B221; XC-C227, XC 8203 and XK-601 from King Industries, TIB KAT 716, 716LA, 716XLA, 718, 720, 789 from TIB Chemicals and those from Shepherd Lausanne, and also for example Borchi® Kat 24; 315; 320 from OMG Borchers GmbH, Langenfeld, Germany;
acetylacetonates of iron, titanium, aluminum, zirconium, manganese, nickel, zinc and cobalt;
zirconium, titanium and aluminum compounds, e.g. zirconium tetraacetylacetonate (e.g. K-KAT® 4205 from King Industries); zirconium dionates (e.g. K-KAT® XC-9213; XC-A 209 and XC-6212 from King Industries); aluminum dionate (e.g. K-KAT® 5218 5 from King Industries).

Further metal catalysts are described by Blank et al. in Progress in Organic Coatings, 1999, vol. 35, pages 19-29.

Preferably, no dialkyltin(IV) salts are used. Preference is given to using zinc catalysts. Among the zinc catalysts, preference is given to the zinc carboxylates, particularly preferably those of carboxylates which have at least six carbon atoms, very particularly preferably at least eight carbon atoms, in particular zinc(II) diacetate or zinc(II) dioctoate or zinc(II) neodecanoate. Standard commercial catalysts are, for example, Borchi® Kat 22 from OMG Borchers GmbH, Langenfeld, Germany, and also TIB KAT 616, TIB KAT 620 and TIB KAT 635, each from TIB Chemicals AG, Mannheim, Germany.

It is possible to additionally enhance the effect of the catalysts through the presence of acids, for example by acids with a pKa value of <2.5, as described in EP 2316867 A1 or with a pKa value between 2.8 and 4.5, as described in WO 04/029121 A1. Preference is given to using acids with a pKa value of not more than 4.8, particularly preferably of not more than 2.5.

It is also conceivable to carry out the reaction without catalyst; however, in this case, the reaction mixture has to be subjected to higher temperatures and/or longer reaction times.

The reaction takes place preferably in an aprotic organic solvent. Examples thereof are aliphatic ketones, in particular those having 3 to 8 carbon atoms, mono-C₁-C₄-alkyl esters of aliphatic monocarboxylic acids, in particular esters of acetic acid, aliphatic ethers, e.g. di-C₁-C₄-alkyl ethers and mixtures thereof, and mixtures with hydrocarbons. Preferred solvents are aliphatic ketones, in particular those having 3 to 8 carbon atoms, such as acetone, methyl ethyl ketone, diethyl ketone and cyclohexanone and mixtures thereof. The amount of solvent is generally selected such that the viscosity of the reaction mixture permits a thorough mixing and at the same time the concentration of the reactants is as high as possible.

The required reaction times can vary from a few minutes to several hours. It is known in the field of polyurethane chemistry how the reaction time is influenced by a large number of parameters such as temperature, concentration of the monomers, reactivity of the monomers.

Suitable polymerization apparatuses are stirred-tank reactors, particularly if a low viscosity and a good heat dissipation is provided for through co-use of solvents. If the reaction is carried out without dilution, then particularly extruders, in particular self-cleaning multiscrew extruders, are suitable on account of the mostly high viscosities and the mostly only short reaction times.

The average particle size (z average), measured by means of dynamic light scattering with the Malvern B autosizer 2 C, of the polyurethane dispersions prepared in this way is not essential to the invention and is generally less than 1000 nm, preferably less than 500 nm, particularly preferably less than 200 nm. The average particle size is very particularly preferably in the range from 20 to 200 nm.

The polyurethane dispersions generally have a solids content of from 10 to 75% by weight, preferably from 20 to 65% by weight, and a viscosity in the range from 10 to 500 mPa·s (ICI cone-plate viscosimeter with measuring head C in accordance with ASTM D4287), measured at a temperature of 20° C. and a shear rate of 250 s⁻¹).

In the field of polyurethane chemistry, it is generally known how the molecular weight of the polyurethanes can be adjusted through choice of the fractions of the monomers reactive with one another, and the arithmetic mean of the number of reactive functional groups per molecule.

The dispersion in step A2) takes place in accordance with methods known to the person skilled in the art, for example using ultrasound. Dispersion can be facilitated by adding further solvents.

Preferably, the step B), the radical polymerization of a monomer composition PA-M, takes place in such a way that
B1) firstly some of the polymerization initiator and some of the monomer composition PA-M is added to the aqueous polymer dispersions of the polyurethane PU and the polymerization is initiated,
B2) after at least partial polymerization of the monomers of the monomer composition

PA-M present in the polymer dispersions, further monomer composition PA-M is added.

The addition in step B2) can take place continuously or discontinuously.

In a preferred embodiment, the addition in step B) takes place such that the polyurethane (PU) is initially introduced and the polymerization is started by adding the initiator and some of the monomer composition (PA-M). Following complete or partial reaction of the monomers of the monomer composition (PA-M), further monomer composition (PA-M) is then introduced and the polymerization is continued to essentially complete conversion.

In a further preferred embodiment, the polyurethane (PU) is initially introduced and some of the monomer composition (PA-M) and some of the initiator are metered in simultaneously at the start. Following complete or partial reaction of the monomers of the monomer composition (PA-M), further monomer composition (PA-M) is then introduced and the polymerization is continued to essentially complete conversion.

In both described embodiments, the monomer composition can be spread over several feeds and, independently of one another, be provided with variable dosing rate and/or variable content of one or more monomers.

“Essentially complete conversion” means a conversion of more than 85%, preferably more than 95%, and particularly preferably more than 98%, based on the total amount of monomer composition used (PA-M).

The addition of the initiator or of the initiator system can take place continuously or discontinuously.

Preferably, the addition of the initiator or of the initiator system takes place in a plurality of steps.

The initiator or the initiator system can be distributed over a plurality of feeds and, independently of one another, be provided with a variable dosing rate and/or variable content of one or more components.

If the initiator or the initiator system comprises a plurality of components, these can be added in succession or simultaneously. The reducing component (I2) of the initiator (I) is generally added briefly after the start of the addition of component (I1), but can also be added at the same time as component (I1).

In a preferred embodiment, some of the initiator or the initiator system is added following the complete addition of the monomer composition.

Optionally, it is also possible for molecular mass regulators to be present. By virtue of the presence of molecular mass regulators in a polymerization, as a result of chain termination and start of a new chain by the new radical thus formed, as a rule the molecular mass of the resulting polymer is reduced and, in the presence of crosslinkers, the number of crosslinking sites (crosslinking density) is also reduced. If, in the course of a polymerization, the concentration of regulator is increased, then the crosslinking density in the course of the polymerization is further reduced. Such molecular mass regulators are known, for example they may be mercapto compounds, such as preferably tertiary dodecyl mercaptan, n-dodecyl mercaptan, isooctylmercapto-propionic acid, mercaptopropionic acid, dimeric α-methylstyrene, 2-ethylhexylthio-glycolic acid ester (EHTG), 3-mercaptopropyltrimethoxysilane (MTMO) or terpinoline. The molecular mass regulators are known and described, for example, in Houben-Weyl, Methoden der organischen Chemie [Methods of organic chemistry], vol. XIVII, p. 297 ff., 1961, Stuttgart.

The polymerization is carried out according to the invention at a temperature of not more than 95° C. Preferably, the temperature is in the range from 50 to 85° C., particularly preferably in the range from 60 to 85° C.

The aqueous polymer dispersions can be subjected, if desired, to a physical deodorization following preparation. A physical deodorization may consist in stripping the polymer dispersion with steam, an oxygen-containing gas, preferably air, nitrogen or supercritical carbon dioxide, for example in a stirred container, as described in DE-B 12 48 943, or in a counterflow column, as described in DE-A 196 21 027.

The invention further provides the use of an aqueous polymer dispersion according to the invention for producing adhesives, and the use of an aqueous polymer dispersion which has been prepared by the process according to the invention for producing adhesives.

Preferred adhesives are pressure-sensitive adhesives for producing sticky labels, sticky tapes, plasters, bandages and self-adhesive films.

The adhesives can comprise further additives, for example fillers, dyes, flow auxiliaries and in particular tackifiers (tackifying resins).

Tackifiers are, for example, natural resins, such as rosins and derivatives thereof produced by disproportionation or isomerization, polymerization, dimerization, hydration. These may be present in their salt form (with e.g. mono- or polyvalent counterions (cations) or preferably in their esterified form. Alcohols that are used for the esterification may be mono- or polyhydric. Examples are methanol, ethanediol, diethylene glycol, triethylene glycol, 1,2,3-propanethiol, pentaerythritol. The amount by weight of the tackifiers is preferably 5 to 100 parts by weight, particularly preferably 10 to 50 parts by weight, based on 100 parts by weight of the adhesive composition.

The invention further provides pressure-sensitive adhesive articles, where at least some of a substrate surface is coated
i) with at least one aqueous polymer dispersion according to the invention and/or
ii) with at least one aqueous polymer dispersion which has been prepared by the process according to the invention.

The substrate may be e.g. paper, plastic films made of polyolefins or polyvinyl chloride.

### Examples

The following products and abbreviations are used:
Polyisocyanate-1: polyisocyanate based on HDI with an NCO functionality of . . . , solvent-free; for example obtainable as Basonat® HI 100 from BASF SE
PPG-diol-1: poly(propylene glycol)diol with Mw≈2000 g/mol and OH number=55; for example obtainable as Lupranol® 1000/1 from BASF SE
PPG-diol-2: poly(propylene glycol)diol with Mw≈4000 g/mol and OH number=28; for example obtainable as Lupranol® 1005/1 from BASF SE
EP-PO-EO copolymer: ethylene oxide/propylene oxide/ethylene oxide block copolymer with a propylene oxide fraction of 90% and Mw≈1000 g/mol; for example obtainable as Pluronic® PE 3100 from BASF SE
Polyesterol-1: aliphatic polyesterol with Mw≈2000 g/mol and OH number=56; for example obtainable as Lupraphen® 6607/1 from BASF SE
Polyesterol-2: aromatic polyesterol with Mw≈2000 g/mol and OH number=56; for example obtainable as Lupraphen® 7600/1 from BASF SE
Polyesterol-3: polyesterol based on dimer fatty acid with Mw≈2000 g/mol and OH number=56; for example obtainable as Priplast® 3192 from Croda
Polycarbonatediol-1: aliphatic polycarbonatediol with Mw≈2000 g/mol and OH number=56; for example obtainable as Desmophen® C2200 from Bayer MaterialScience
Dipropylene glycol dimethyl ether: dipropylene glycol dimethyl ether mixture, for example obtainable as Proglyde™ DMM from Dow
Dissolvine® E-Fe-6: ethylenediaminetetracetic acid, iron potassium salt
Rongalit® C: sodium hydroxymethanesulfinate dihydrate
E316: sodium erythorbate
TEGO® Foamex 831: mixture of defoaming and deaerating substances, silicone-free. Formulation based on hydrophobic organic active ingredients and dispersed solids, silicone-free and mineral oil-free; defoamer from Evonik
Afranil MG: water-emulsifiable defoamer with aliphatic, hydroxy compounds; defoamer from BASF SE

The following abbreviations are used:

tBHP: tert-butyl hydroperoxide
EHA: 2-ethylhexyl acrylate
S: styrene
EA: ethyl acrylate
MA: methyl acrylate
MMA: methyl methacrylate
nBA: n-butyl acrylate
GMA: glycidyl methacrylate
HPA: hydroxypropyl acrylate
VAc: vinyl acetate
DMF: dimethylformamide
HCl: hydrogen chloride
Bromophenol blue: 3,3′,5,5′-tetrabromophenolsulfonphthalein
NMP: 1-methyl-2-pyrrolidone
SC: solids content
rpm: revolutions per minute

Unless stated otherwise, the following analysis methods are used:

### HDC (Hydrodynamic Radius)

The hydrodynamic radius is determined via hydrodynamic chromatography. In each sample, a marker is added 45 seconds after the sample; this links the particle size with the flow time. Thus, the precise particle size can be determined from the flow time, the retention time.

### LD (Light Transmission)

The light transmission describes a parameter in order to determine particle size differences. Here, the polymer dispersion is diluted to a solids content of 0.01% and the light transmission is measured compared to pure water.

### Tg (Calculated)

The glass transition temperature Tg is calculated according to the Fox equation from the glass transition temperature of the homopolymers of the monomers present in the copolymer and their weight fractions as follows:

1/Tg=xA/TgA+xB/TgB+xC/TgC+ . . . .

Tg: calculated glass transition temperature of the copolymer
TgA: glass transition temperature of the homopolymer of monomer A
TgB, TgC: Tg corresponding to monomers B, C, etc.
xA: mass monomer A/total mass of copolymer,
xB, xC corresponding to monomers B, C etc.

### K Value

The K value is a measure of the average molar mass or of the viscosity. In order to determine the K value, a 1% strength DMF solution is prepared and the measurement temperature is 25° C. The viscosities of the individual samples are measured in a Lauda thermostat CD 30 and attached cooling device DLK 30. For this, viscometers of the Ubbelohde type, size 1, are used. To ascertain the flow rates, a Lauda viscometer S is used and the evaluation takes place via an Epson HX-20 computer.

### NCO Value

A 250 ml Erlenmeyer flask is charged, without stirring rods, with 100 ml of NMP and 10 ml of measurement solution, and 1 to 2 g of sample are weighed in precisely and then stirred with stirring rods on a magnetic stirrer to the point of complete dissolution, and then back-titrated with 0.1 N HCl solution to the point of a green coloration. For the measurement solution 25.84 g of dibutylamine (p.A.) and 0.15 g of bromophenol blue are weighed on the analytical balance in 2 l measuring flasks, topped up to 2 l with NMP and then thoroughly mixed until everything has dissolved.

[Blank value (ml)−consumed HCl (ml)×42(MW NCO)]/[initial weight of sample (g)×100]. NCO Calculation Formula:

### Blank Value:

100 ml of NMP and 10 ml of measurement solution are charged to a 250 ml Erlenmeyer flask and back-titrated with stirring with 0.1 N HCl solution until the color changes from blue to green. The blank value corresponds to the ml consumption of the HCl solution.

### GPC (Gel Permeation Chromatography)

The determination of the number-average and weight-average molar mass Mₙ and M_{w} refer here, unless stated otherwise, to gel permeation chromatographic measurements via size exclusion chromatography in accordance with DIN 55672-2:2008:06, with polymethyl methacrylate being used as standard and tetrahydrofuran being used as eluent.

Unless stated otherwise, the following instrument parameters were used:

### Instrument: PSS Agilent Technologies 1260 Infinity

Columns: 1×PLGel Mixed E Guard (precolumn), length 5 cm, diameter 0.75 cm
1×PLGel Mixed E, length 30 cm, diameter 0.75 cm
1×PLGel Resipore, length 30 cm, diameter 0.75 cm

### Solvent: THF

Flow rate: 1 mL/min
Injection volume: 50 μL

### Concentration: 1 g/L

Temperature: room temperature (20° C.)

### FFF (Field Flow Fractionation)

For samples whose molar mass M_{w} was not able to be ascertained by means of GPC on account of significant gel fractions (=cloudy THF solution), the determination of the gel content and also of the average molar mass \dot{M}_{w} was carried out by means of field flow fractionation FFF.

To determine the field flow fractionation FFF, the colloidal sample (7 g/l in THF) was separated by the cross flow in a narrow fractionation channel according to the hydrodynamic radius; the eluent used was THF. The radius of all fractions was read off from the angle distribution of the multiangle light scattering detector, the molar mass of each fraction result from the comparison of refractive index detector and light scattering detector; for the evaluation, do/dc=0.08 cm³/g was used. For the determination of the sol fractions, prefiltration was carried out above 0.2 μm, and for those of the gel fractions above 5.0 μm. Missing fractions, i.e. in the case of a recovery rate <100%, could either have been retained in the prefilter (=gel bodies >5 μm) or have escaped through the separation membrane (=low molecular weight constituents with M_{w}<5 kDa). The resulting measurement values for % sol and % gel were correspondingly corrected according to their behavior during sample preparation and add up to 100%. The average molar mass \dot{M}_{w} is calculated from the formula \dot{M}_{w}=% sol×M_{w}(sol)+% gel×M_{w}(gel).

### Settings/Separation Method:

| | Flow rate | Cross flow | Focus |
|---|---|---|---|
| Sol fractions | 0.7 mL/min | 3.0 const. 5 min to 0.1 | 133 |
| | | mL/min in 20 min | |
| Gel fractions | 0.7 mL/min | 3.0 const. 3 min to 0.1 | 133 |
| | | mL/min in 15 min | |

### Synthesis of the Polyurethane Dispersions

### General Process PU-1, Explained by Way of Example for PUD 1

In a 3 l HWS stirred-tank reactor with reflux condenser, 800 g of PPG-diol-1 and 64 g of 2,2-dimethylolpropionic acid were heated to 60° C. and stirred at 100 rpm. At this temperature, 150 g of toluene 2,4-diisocyanate were added and rinsed with 100 g of acetone. The mixture was stirred for 5 hours at 98° C. and the resulting polyurethane (end NCO content <0.25%) was then diluted with 1 l of acetone with vigorous stirring at 200 rpm. Then, 20 g of triethylamine were added as neutralizing agent and the mixture was after-stirred at 120 rpm for 5 minutes. The dispersion was carried out with stirring at 120 rpm by adding 1.5 l of demin. water. After adding 1 g of Afranil MG and 2 drops of silicone defoamer to the mixture, the acetone was removed by distillation in vacuo at 100 mbar (external temperature 75° C., internal temperature up to 43° C.), the solids content of the resulting polyurethane dispersion was determined and the mixture was adjusted to the desired solids content with demin. water. Then, the polyurethane dispersion was filtered over a 400 μm filter to remove possible impurities.

The polyurethane dispersion PUD 1 with 40% solids content, K value=37.4, LD value=74 and pH=6.4 was obtained.

The preparation of the polyurethane dispersions PUD 2 to PUD 5 was carried out in an analogous manner, the type and amounts of the feed materials being varied as shown in table 1.

TABLE 1
overview of the PPG-based PU dispersions prepared
by process PU-1 (according to the invention).

| | PUD-1 | PUD-2 | PUD-3 | PUD-4 | PUD-5 |
|---|---|---|---|---|---|
| PPG-diol-1 [g] | 800.0 | 800.0 | 800.0 | 800.0 | 800.0 |
| DMPA [g] | 64.0 | 80.3 | 64.0 | 80.3 | 74.5 |
| TDI [g] | 150.0 | 173.8 | 150.0 | 173.5 | — |
| HDI [g] | — | — | — | — | 160.7 |
| NEt₃ [g] | 20.0 | 60.6 | — | — | — |
| NaOH (50% | — | — | 11.5 | — | — |
| strength) [g] | | | | | |
| NH₃ (23% strength) | — | — | — | 17.7 | 16.5 |
| [g] | | | | | |
| SC | 40.0 | 20.0 | 51.2 | 40.0 | 46.3 |
| AN [g KOH/kg] | 26.4 | 31.9 | 26.4 | 31.9 | 29.9 |
| NG | 40% | 100% | 30% | 40% | 40% |
| K value | 36.3 | — | 41.5 | 33.5 | 43.9 |
| Mn [kDa] | 22.0 | 23.8 | — | — | — |
| Mw [kDa] | 85.8 | 88.3 | — | — | — |
| Particle size | 174 | — | — | 386 | — |
| (DLS) [nm] | | | | | |
| Particle size | 176 | 21 | — | — | — |
| (HDC) [nm] | | | | | |

### General Procedure PU-2 (Synthesis of PUD6 to PUD9, not According to the Invention)

In a stirred-tank reactor with reflux condenser, 365.2 g of polyol component, 30.9 g of 2,2-dimethylolpropionic acid, 0.9 g of ethanol and 44 g of acetone are initially introduced at 60° C. and admixed, with stirring, with a mixture of 73.65 g of toluene 2,4-diisocyanate in 7.2 g of acetone. The reaction mixture was heated to 90° C. and held at this temperature for several hours. After dilution with a further 366 g of acetone and simultaneous cooling to 50° C., the resulting polyurethane was neutralized by adding 9.3 g of triethylamine and then after-stirred for 5 minutes. The dispersion was carried out with stirring by adding 0.6 l of demin. water over the course of 15 minutes. After adding 2 ml of Afranil® MG, the acetone was removed by distillation in vacuo at 55° C.

Details relating to the polyurethane dispersions PUD-6 to PUD-9 prepared in this way can be found in table 2.

TABLE 2
Overview of the PU dispersions prepared by process PU-2
(not according to the invention).

| | PUD-6 | PUD-7 | PUD-8 | PUD-9 |
|---|---|---|---|---|
| Polyol | Polyesterol-1 | Polyesterol-2 | Polyesterol-3 | Polycarbonatediol- |
| component | | | | 1 |
| SC [%] | 49.7 | 42.9 | 41.3 | 44.3 |
| Particle | 404 | 105 | 81 | 102 |
| size (DLS) | | | | |
| [nm] | | | | |
| pH | 6.3 | 6.4 | 6.2 | 6.4 |
| Mn [kDa] | 7.1 | 12.7 | 13.1 | 12.5 |
| Mw [kDa] | 24.2 | 44.1 | 47.6 | 43.6 |
| End NCO | 0.07 | 0.12 | 0.17 | 0.19 |
| [%] | | | | |

### Synthesis of PUD-10 (Analogous to EP 334032, not According to the Invention)

In a stirred-tank reactor with reflux condenser, 214.6 g of PPG-diol-1, 76.0 g of hydroxypivalic acid, 161.0 g of polyisocyanate-1 and 23.8 g of acetone were initially introduced at room temperature, then the mixture was heated to 100° C. with stirring and held at this temperature for 6 hours. Following dilution with 510.6 g of acetone and simultaneous cooling to 50° C., the resulting oligourethane (end NCO=0%) was neutralized by adding 54.3 g of triethylamine over the course of 20 minutes and after-stirring for 5 minutes. The dispersion was carried out with stirring by adding 760 ml of demin. water over the course of 25 minutes. After adding 8 ml of TEGO Foamex 831 (10% strength in acetone), the acetone was removed by distillation in vacuo. This gave a polyurethane dispersion with 40.1% solids content, pH 6.7, M_{W}=14 300 g/mol, M_{N}=3790 g/mol and an average particle size (DLS) of 40 nm.

Synthesis of PUD-11 (Analogously to Adler et al., Prog. Org. Coat. 2001, not According to the Invention)

A stirred-tank reactor with reflux condenser is charged with 261.8 g of EP-PO-EO copolymer, 36.9 g of 2,2-dimethylolpropionic acid, 17.9 g of hydroxyethyl methacrylate and 12.1 g of 1-pentanol. Then, the mixture was heated to 50° C. with stirring and admixed with 153.1 g of isophorone diisocyanate over the course of 20 minutes. After rinsing with 13 g of acetone, the reaction mixture was heated to 100° C. and kept at this temperature for 6 hours. After dilution with 558 g of acetone and simultaneous cooling to 50° C., the resulting oligourethane (end NCO=0.07%) was neutralized by adding 27.5 g of diethanolamine over the course of 5 minutes and after-stirred for 15 minutes. The dispersion was carried out with stirring by adding 720 ml of demin. water over the course of 15 minutes. After adding 10 ml of TEGO Foamex® 831 (10% strength in acetone), the acetone was removed by distillation in vacuo. This gave a polyurethane dispersion with 36.7% solids content, pH 7.4, M_{W}=9210 g/mol, M_{N}=3730 g/mol and an average particle size (DLS) of 30 nm.

### Synthesis of PUD-12 (not According to the Invention)

In a stirred-tank reactor with reflux condenser, 580 g of PPG-diol-2, 72 g of 1,4-butanediol, 40 g of 2,2-dimethylolpropionic acid and 750 g of dipropylene glycol dimethyl ether (PROGLYDE™ DMM) were initially introduced and heated to 60° C. With stirring at 100 rpm, 298 g of isophorone diisocyanate were added and rinsed with 60 g of dipropylene glycol dimethyl ether. The mixture was stirred for 5 hours at 98° C. Then, with vigorous stirring at 200 rpm, 3 g of hydrazine were added as chain extender and 6.8 g of triethylamine were added as neutralizing agent to the resulting polyurethane (end NCO=0.443%) and after-stirred at 120 rpm for 5 minutes. The dispersion was carried out with stirring at 120 rpm by adding 1.38 l of demin. water. This gave a polyurethane dispersion with 42% solids content, the M_{W} of which could not be determined by means of GPC on account of insolubility in THF. A gel fraction of 35% was determined by means of FFF analysis, the average molar mass \dot{M}_{w} was 54 MDa.

### Synthesis of PUD-13 (not According to the Invention)

A stirred-tank reactor with reflux condenser was charged with 211.1 g of PPG-diol-1, 21.2 g of 2,2-dimethylolpropionic acid, 38.0 g of 1,4-butanediol and 52 g of acetone. Then, the mixture was heated to 65° C. with stirring, and admixed with a mixture of 182.7 g of isophorone diisocyanate and 10.3 g of acetone, and the mixture was kept at 80° C. for 2.75 hours. Following dilution with 366 g of acetone and simultaneous cooling to 50° C., the resulting polyurethane (end NCO=1.21%) was transferred to a distillation reactor and admixed at 30° C. with 2.1 g of isophorone diamine as chain extender. Then, over the course of 6 minutes, 16.7 g of diethylethanolamine were added dropwise as neutralizing agent and the mixture was after-stirred for 5 minutes. The dispersion was carried out with stirring by adding 760 ml of demin. water over the course of 19 minutes. Directly afterwards, a solution of 4.1 g of diethylenetriamine was added dropwise as crosslinker in 80.4 g of water over the course of 16 minutes. After adding 1 ml of TEGO Foamex® 831, the acetone was removed by distillation in vacuo. This gave a polyurethane dispersion with 34.0% solids content, pH 7.6 and an average particle size (DLS) of 506 nm, the M_{w} of which could not be determined by means of GPC on account of its solubility in THF. The gel fraction of 45% was determined by means of FFF analysis, the average molar mass \dot{M}_{w} was 50 MDa.

### Synthesis of the PU/PA Hybrid Dispersions

The PU/PA hybrid dispersions were produced by 3 different methods, with methods HD-M1 (described by reference to hybrid dispersion 6) and HD-M2 (described by reference to hybrid dispersion 20) differing merely in the addition of the initiator system and producing virtually identical application properties for an identical monomer composition. The third method, HD-M3, by contrast, differs from method HD-M1 and HD-M2 in the addition of the monomers and produces significantly different application properties. All of the comparative examples are labeled with the prefix “C”.

### General Process HD-M1, Explained by Way of Example for Hybrid Dispersion 6 (“Feed Method”)

A mixture of 20 g of water, 0.13 g of a 40% strength Dissolvine® E-Fe-6 solution and 625 g of the PUD-1 was heated to 85° C. under a nitrogen atmosphere and stirred for 5 minutes. In each case 10% of the initiator feeds 1 and 2 were added to this mixture and stirred. This was followed by the metered addition of the monomer feed consisting of 141.25 g of EHA and 108.75 g of styrene, over the course of 2.5 hours and 5 minutes later over the course of 4 hours the metered addition of the remainder of both initiator feeds 1 and 2. This was followed by the addition of 10 g of water and an after-polymerization of 15 minutes at a temperature of 85° C., and after cooling the reaction mixture it was filtered.

### Initiator Feed 1 (Reducing Agent):

3.2 g of Rongalit© C and 111.25 g of water

### Initiator Feed 2 (Oxidizing Agent):

37 g of tBHP (10% strength solution) and 70 g of water

In an analogous manner, further hybrid dispersions were synthesized, varying the polyurethane dispersion used, the composition of the monomer feed as well as the amount and type of initiator. An overview of the relevant parameters and the properties of the corresponding hybrid dispersions is given in tables 3 and 4.

TABLE 3
overview of the PU/PA hybrid dispersions prepared
according to process HD-M1

| Hybrid | PUD, | Monomers, | Initiator 1, | Initiator 2, |
|---|---|---|---|---|
| dispersion | amount¹⁾ | amount | amount¹⁾ | amount¹⁾ |
| 4 | PUD-1, | EA, 212.5 g | Rongalit © C, | tBHP (10% strength |
| | 625 g | nBA, 37.5 g | 3.2 g | solution), 37 g |
| 6 | PUD-1, | EHA, 141.25 g | Rongalit © C, | tBHP (10% strength |
| | 625 g | S, 108.75 g | 3.2 g | solution), 37 g |
| 8 | PUD-1, | MA, 125 g | Rongalit © C, | tBHP (10% strength |
| | 625 g | EA, 125 g | 3.2 g | solution), 37 g |
| 9 | PUD-1, | MA, 187.5 g | Rongalit © C, | tBHP (10% strength |
| | 625 g | EA, 62.5 g | 3.2 g | solution), 37 g |
| 10 | PUD-1, | MA, 250 g | Rongalit © C, | tBHP (10% strength |
| | 625 g | | 3.2 g | solution), 37 g |
| 11 | PUD-4, | MA, 338 g | E316, 3.6 g | tBHP (10% strength |
| | 750 g | GMA, 6.9 g | | solution), 40.5 g |
| 12 | PUD 5, | MA, 274.4 g | Rongalit © C, | tBHP (10% strength |
| | 605 g | GMA, 5.6 g | 3.2 g | solution), 37 g |
| 13 | PUD-1, | MMA, 125 g | Rongalit © C, | tBHP (10% strength |
| | 625 g | EA, 125 g | 3.2 g | solution), 37 g |
| C14 | PUD-1, | MMA, 187.5 g | Rongalit © C, | tBHP (10% strength |
| | 625 g | EA, 62.5 g | 3.2 g | solution), 37 g |
| C15 | PUD-1, | MMA, | Rongalit © C, | tBHP (10% strength |
| | 625 g | 250 g | 3.2 g | solution), 37 g |
| 16 | PUD-1, | EA, 350 g | Rongalit © C, | tBHP (10% strength |
| | 375 g | | 3.2 g | solution), 37 g |
| 17 | PUD-1, | EA, 150 g | Rongalit © C, | tBHP (10% strength |
| | 875 g | | 3.2 g | solution), 37 g |
| 19 | PUD-3, | EA, 175 g | Rongalit © C, | tBHP (10% strength |
| | 146 g | | 1.6 g | solution), 18.5 g |
| 20 | PUD-3, | EA, 125 g | Rongalit © C, | tBHP (10% strength |
| | 244 g | | 1.6 g | solution), 18 g |
| 21 | PUD-3, | EA, 75 g | Rongalit © C, | tBHP (10% strength |
| | 341 g | | 1.6 g | solution), 18.5 g |
| 22 | PUD-4, | EA, 300 g | Rongalit © C, | tBHP (10% strength |
| | 500 g | | 3.2 g | solution), 37 g |
| 23 | PUD-4, | MA, 250 g | Rongalit © C, | tBHP (10% strength |
| | 625 g | | 3.2 g | solution), 37 g |

¹⁾The amount of water given in the formulation HD-M1 in the feeds and in the initial charge was changed in the corresponding ratio such that the theoretical SC given in table 4 was reached. The monomer conversion for all of the dispersions was >99.9%.

TABLE 4
wet sample values of the PU/PA hybrid dispersions from table 3.

| Hybrid | | | | |
|---|---|---|---|---|
| dispersion | theor. SC [%] | SC [%] | pH | LT [%] |
| 4 | 45 | 43.4 | 6.4 | 85 |
| 6 | 45 | 44.8 | 6.3 | 79 |
| 8 | 45 | 42.9 | 6.3 | 83 |
| 9 | 45 | 42.4 | 6.4 | 83 |
| 10 | 45 | 42.9 | 6.4 | 83 |
| 11 | 47 | 46.5 | 6.1 | 88 |
| 12 | 45 | 45.6 | 5.6 | 74 |
| 13 | 45 | 44.4 | 6.4 | 83 |
| C14 | 45 | 44.5 | 6.4 | 84 |
| C15 | 45 | 44.4 | 6.5 | 84 |
| 16 | 43.1 | 42.4 | 6.1 | 82 |
| 17 | 43.1 | 43.6 | 6.4 | 86 |
| 19 | 45 | 44.3 | 6.4 | 77 |
| 20 | 45 | 44.7 | 6.3 | 82 |
| 21 | 45 | 44.9 | 6.5 | 84 |
| 22 | 50 | 51.9 | 6.0 | 87 |
| 23 | 50 | 49.4 | 6.2 | 86 |

### General Process HD-M2, Explained by Way of Example for Hybrid Dispersion 5 (“Feed Method”)

A mixture of 100 g of water, 1.5 g of a 1% strength Dissolvine® E-Fe-6 solution and 187.5 g of PUD-1 was heated to 85° C. under a nitrogen atmosphere with stirring at 150 rpm. Then, 9.0 g of a 10% strength, aqueous tBHP solution were added and the mixture was after-stirred for 5 minutes. Then, over the course of 4 hours at a reaction temperature of 85° C., the monomer feed, consisting of 75.0 g of ethyl acrylate, and in parallel to this, the reducing agent feed, consisting of a solution of 0.63 g of Rongalit® C in 20.37 g of water, were metered in. After the end of the feeds, after-polymerization was carried out at 85° C. for 15 minutes. Finally, a chemical deodorization was carried out for further depletion of the monomers, feeds 3 and 4 being metered in at 85° C. over the course of an hour for this purpose. Following cooling of the reaction mixture, it was filtered. This gave a PU/PA hybrid dispersion with 34.5% solids content (theoretically 35.1%), a pH of 6.4 and a bimodal particle size distribution (59/145 nm).

### Feed 3 (Reducing Agent):

0.32 g of Rongalit® C and 10.44 g of water

### Feed 4 (Oxidizing Agent):

2.06 g of tBHP (10% strength solution) and 18.0 g of water

In an analogous manner, further hybrid dispersions were synthesized, varying the polyurethane dispersion used or the composition of the monomer feed. An overview of the relevant parameters and also the properties of the corresponding hybrid dispersions is shown in table 5.

TABLE 5
overview of the PU/PA hybrid dispersions prepared
according to process HD-M2

| Hybrid | PUD, | Monomers, | SC | | Particle size |
|---|---|---|---|---|---|
| dispersion | amount ¹⁾ | amount | [%] | pH | (HDC) [nm] |
| 1 | PUD-1, 125 g | EHA, 42 g | 30.1 | 6.0 | 57/131 |
| | | MMA, 4 g | | | |
| | | VAc, 4 g | | | |
| 2 | PUD-1, 125 g | EHA, 42 g | 27.3 | 6.8 | 60/131 |
| | | MMA, 8 g | | | |
| 3 | PUD-1, 129 g | nBA, 22.5 g | 32.1 | 6.3 | 60/142 |
| | | EHA, 15.0 g | | | |
| | | MMA, 7.5 g | | | |
| | | S, 5.0 g | | | |
| 5 | PUD-1, | EA, 75 g | 34.5 | 6.4 | 59/145 |
| | 187.5 g | | | | |
| 7 | PUD-1, 147 g | nBA, 17.7 g | 32.4 | 6.4 | 60/142 |
| | | EHA, 12.5 g | | | |
| | | MMA, 12.5 g | | | |
| | | S, 7.5 g | | | |
| 18 | PUD-2, 375 g | EA, 75 g | 26.0 | 7.0 | 30 |
| C28 | PUD-6, 101 g | EHA, 42 g | 35.3 | 6.0 | 71/542 |
| | | MMA, 8 g | | | |
| C29 | PUD-6, 101 g | EA, 50 g | 36.5 | 6.8 | 75/526 |
| C30 | PUD-7, 117 g | EHA, 42 g | 34.9 | 5.8 | 115 |
| | | MMA, 8 g | | | |
| C31 | PUD-7, 117 g | EA, 50 g | 37.4 | 6.0 | 115 |
| C32 | PUD-8, 121 g | EHA, 42 g | 34.3 | 5.9 | 84 |
| | | MMA, 8 g | | | |
| C33 | PUD-8, 121 g | EA, 50 g | 34.7 | 5.9 | 79 |
| C34 | PUD-9, 113 g | EHA, 42 g | 35.4 | 6.1 | 109 |
| | | MMA, 8 g | | | |
| C35 | PUD-9, 113 g | EA, 50 g | 36.2 | 6.2 | 109 |
| C36 | PUD-10, | EHA, 85 g | 34.1 | 6.9 | 56 |
| | 249.4 g | MMA, 15 g | | | |
| C37 | PUD-10, | EA, 100 g | 33.5 | 7.0 | 51 |
| | 249.4 g | | | | |
| C38 | PUD-11, | EHA, 42.5 g | 32.8 | 7.5 | 31/68 |
| | 136.2 g | MMA, 7.5 g | | | |
| C39 | PUD-11, | EA, 50 g | 34.5 | 6.5 | 560 |
| | 136.2 g | | | | |
| C40 | PUD-12, 137 g | EHA, 42.5 g | 31.6 | 7.5 | 3 |
| | | MMA, 7.5 g | | | |
| C41 | PUD-12, 137 g | EA, 50 g | 35.5 | 7.5 | 67 |
| C42 | PUD-13, | EHA, 42.5 g | 34.4 | 8.0 | Not |
| | 147.1 g | MMA, 7.5 g | | | determined |
| C43 | PUD-13, | EA, 50 g | 33.5 | 7.6 | Not |
| | 147.1 g | | | | determined |

¹⁾ If a different solids content than the one described in formulation HD-M2 had been attained, then the stated amounts of water in the feeds and in the initial charge were adapted accordingly. The monomer conversion for all of the dispersions was >99.5%.

### General Process HD-M3, Explained by Way of Example for Hybrid Dispersion C25 (“Batch Method”, not According to the Invention)

In a 2 l flat-flange apparatus, 97.75 g of PUD-3 were mixed, under a nitrogen atmosphere, with 37.5 g of ethyl acrylate, 12.5 g of n-butyl acrylate, 1.33 g of tert-butyl perpivalate and 0.03 g of a 40% strength Dissolvine® E-Fe-6 solution, and the reaction mixture was then topped up with 52.9 g of water. With stirring, the mixture was heated to 85° C. over the course of one hour and then kept at this temperature with constant stirring for 3 hours in order to guarantee the necessary depletion of the monomers. After cooling the reaction mixture, it was filtered. This gave a PU/PA hybrid dispersion with 43.7% solids content (theoretically 45%), a pH of 7.2 and a LT value of 80%.

In an analogous manner, further hybrid dispersions were synthesized, varying the polyurethane dispersion used or the composition of the monomer feed. An overview of the relevant parameters and the properties of the corresponding hybrid dispersions is given in the table below.

TABLE 6
overview of the PU/PA hybrid dispersions
prepared according to process HD-M3

| | | | | | | Particle |
|---|---|---|---|---|---|---|
| Hybrid | PUD, | Monomers, | SC | | LT | size (HDC) |
| dispersion | amount ¹⁾ | amount | [%] | pH | [%] | [nm] |
| C24²⁾ | PUD-1, | EHA, 42.0 g | 45.5 | 6.6 | — ³⁾ | 70 |
| | 125 g | MMA, 8.0 g | | | | |
| | | EHTG, 0.4 g | | | | |
| C25 | PUD-3, | EA, 37.5 g | 43.7 | 7.2 | 80 | — ³⁾. |
| | 97.75 g | nBA, 12.5 g | | | | |
| C26 | PUD-1, | EHA, 141.25 g | 45.2 | 6.3 | 86 | 102 |
| | 625 g | S, 108.75 g g | | | | |
| C27 | PUD-3, | EA, 37.5 g | 39.1 | 7.1 | 80 | — ³⁾ |
| | 97.75 g | MMA, 12.5 g | | | | |

¹⁾ If a different solids content to that described in formulation HD-M3 was attained, then the stated amounts of water in the feeds and in the initial charge were adapted accordingly. The monomer conversion for all of the dispersions was >99.5%.
²⁾Deviating from formulation HD-M3, the addition of Dissolvine ® E-Fe-6 was omitted and an alternative heating program was chosen (to 95° C. in 2 h, then keep for 1 h).
³⁾ Not determined

### Application Tests

The pressure-sensitive adhesives were coated with an application amount of 60 g/m² on PET film Hostaphan® RN 36 as carrier and dried for 5 minutes at 90° C. The carrier coated with pressure-sensitive adhesive was cut into test strips 25 mm in width.

### a) Peel Strength (Adhesion)

To determine the peel strength, the 25 mm-wide test strips were stuck to the test surface made of steel (AFERA steel) or polyethylene and attached by rolling once with a roller weighing 1 kg. The test strip was then clamped at one end into the upper jaws of a stress-strain testing apparatus. The adhesive strip was pulled at 300 mm/min under a 180° angle from the test surface, i.e. the adhesive strip was bent and pulled parallel to the test sheet, and the force expenditure required for this was measured. The measure of the peel strength is the force in N/25 mm which results as an average value from five measurements. The peel strength was determined 24 hours after adhesion. After this time, the adhesive force had fully developed.

### b) Shear Strength (Cohesion)

To determine the shear strength, the test strips were stuck to sheet steel (AFERA steel) with an adhered surface of 12.5×12.5 mm, attached by rolling once with a roller weighing 1 kg and then weighted in a suspended manner with a 1 kg weight. The shear strength (cohesion) was determined under atmospheric conditions (23° C.; 50% relative atmospheric humidity) and at 70° C. The measure of the shear strength is the time in hours until the weight has dropped off; in each case, the average from five measurements was calculated.

### c) S.A.F.T. Test (Heat Resistance)

The test strips were stuck to AFERA steel with an adhered surface of 12.5×12.5 mm, attached by rolling 4 times with a roller weighing 2 kg and, after a contact time of at least 16 hours, weighted in a suspended manner with a 1 kg weight. During the weighing down, heating was carried out continuously starting from 23° C. at a rate of 0.5° C./min. The heating temperature achieved when the weight drops off is a measure of the heat resistance of the adhesive. In each case, the average from three measurements was calculated.

### d) Quickstick (Instantaneous Adhesion)

The determination of the Quickstick was carried out in accordance with the determination of Looptack, described as FINAT test method No. 9 (FTM 9) in handbook No. 6 from FINAT: a test strip 25 mm in width and at least 175 mm in length was clamped in the form of a loop at both ends into the upper jaws of a stress-strain testing apparatus, with the adhesive surface pointing outwards. Then, the lower end of the loop was brought into contact with a PE plate which is aligned perpendicular to the direction of movement of the stress-strain apparatus. For this, the loop was lowered down onto the PE plate at a rate of 300 mm/min until a contact area of 25×25 mm is reached. Then, the stress direction was immediately reversed and the adhesive bond was separated again at a rate of 300 mm/min. The measure of the Quickstick is the maximum force in N/25 mm which has arisen during pulling to the point of complete separation of the adhesive bond. In each case, the average value from 5 measurements was calculated.

### Assessment of the Observed Fracture Pattern

F=adhesive-free film on the substrate
A100 (A)=adhesive layer remains completely on the base film (adhesion fracture)
A0=adhesive layer detaches from the base film and goes over to the substrate (rewind)
K=separation in the adhesive layer without detachment from one of the two materials (cohesion fracture)
K*=separation in the adhesive layer without detachment from one material (cohesion fracture), the adhesive has no residual stickiness
MB=partial or complete fracture of a film
Z=zippy, adhesive layer peels off (rattling noise)

TABLE 7
application results of the polyurethane dispersions PUD1 to PUD-13

| | Quick- | Peel | Shear | Shear | |
|---|---|---|---|---|---|
| | stick¹⁾ | strength²⁾ | strength³⁾ | strength⁴⁾ | |
| | [N/25 mm] | [N/25 mm] | [h] | [h] | |
| | (fracture | (fracture | (fracture | (fracture | S.A.F.T.⁵⁾ |
| PUD | pattern) | pattern) | pattern) | pattern) | [° C.] |
| PUD-1 | 0.4 | 33.6 | 00.5 | 0.07 | 53 |
| | (A) | (Z/F) | (K) | (K) | |
| PUD-2 | 0.1 | 21.8 | 25.7 | 0.3 | 93 |
| | (A) | (A) | (K*) | (K*) | |
| PUD-3 | 0.6 | 60.8 | 00.2 | 0.05 | 53 |
| | (A) | (K/Z) | (K) | (K) | |
| PUD-4 | 0.6 | 112.6 | 00.6 | 0.07 | 51 |
| | (A) | (MB) | (K) | (K) | |
| PUD-5 | 0.7 | 16.3 | <0.02 | <0.02 | 34 |
| | (A) | (K) | (K) | (K) | |
| PUD-6 | 0.0 | 00.1 | <0.02 | <0.02 | 31 |
| | (A) | (F) | (F) | (F) | |
| PUD-7 | 0.2 | 16.4 | 09.1 | 0.08 | 65 |
| | (A) | (A) | (K*) | (K*) | |
| PUD-8 | 0.7 | 38.9 | 00.6 | 0.07 | 52 |
| | (A) | (K/A0) | (K) | (K) | |
| PUD-9 | 0.1 | 03.4 | >100 | 1.1 | 101 |
| | (A) | (A) | | (K*) | |
| PUD-10 | 6.7 | 02.8 | <0.02 | <0.02 | 30 |
| | (K) | (K) | (K) | (K) | |
| PUD-11 | 6.0 | 14.1 | <0.02 | <0.02 | 31 |
| | (Z) | (K) | (K) | (K) | |
| PUD-12 | <0.1 | <0.1 | — ⁶⁾ | — ⁶⁾ | — ⁶⁾ |
| | (A) | (A) | | | |
| PUD-13 | <0.1 | <0.1/A | — ⁶⁾ | — ⁶⁾ | — ⁶⁾ |
| | (A) | | | | |

¹⁾Quickstick on polyethylene
²⁾Peel strength on steel
³⁾Shear strength atmospheric conditions (23° C.; 50% relative atmospheric humidity)
⁴⁾Shear strength at 70° C.
⁵⁾Heat resistance S.A.F.T.
⁶⁾ No testing possible since non-sticky

TABLE 8
Application results of different hybrid dispersions
(PPG-based PUD, PU/PA = 50:50) with varying Tg.

| | | Quickstick¹⁾ | | Peel strength²⁾ | | Shear | Shear | |
|---|---|---|---|---|---|---|---|---|
| | | [N/25 mm] | | [N/25 mm] | | strength³⁾ | strength⁴⁾ | |
| Hybrid | Fox Tg | (fracture | | (fracture | | [h] (fracture | [h] (fracture | S.A.F.T.⁵⁾ |
| dispersion | [° C.] | pattern) | | pattern) | | pattern) | pattern) | [° C.] |
| 1 | −44 | 0.9 | (A) | 11.4 | (A) | 42.1 (F) | >100 | 162 |
| 2 | −42 | 0.9 | (A) | 11.0 | (A) | >100 | >100 | 168 |
| 3 | −24 | 1.3 | (A) | 16.2 | (A) | >100 | >100 | 150 |
| 4 | −14 | 0.9 | (A) | 15.6 | (A) | 93.4 | 11.9 | 174 |
| 5 | −8 | 1.5 | (A) | 15.6 | (A) | >100 | >100 | 170 |
| 6 | −8 | 2.2 | (A) | 24.8 | (A) | >100 | 29.4 | 162 |
| 7 | −6 | 1.5 | (A) | 18.8 | (A) | >100 | >100 | 152 |
| 8 | +6 | 0.8 | (A) | 18.7 | (A) | 28.5 | 36.2 | 170 |
| 9 | +14 | 1.0 | (A) | 18.3 | (A) | >100 | 79.7 | 172 |
| 10 | +22 | 0.5 | (A) | 20.5 | (A) | >100 | | 171 |
| 11^{a,b)} | +22 | 0.3 | (A) | 23.23 | (A) | >100 | >100 | >180 |
| 12^{a)} | +22 | 0.7 | (A) | 21.2 | (A) | 25.4 (A) | >100 | >180 |
| 13 | +39 | 0.2 | (A) | 6.4 | (A) | >100 | | 175 |
| C14 | +69 | <0.1 | (A) | <0.1 | (A) | — ⁶⁾ | — ⁶⁾ | — ⁶⁾ |
| C15 | +105 | <0.1 | (A) | <0.1 | (A) | — ⁶⁾ | — ⁶⁾ | — ⁶⁾ |

^{a)}PUD variant,
^{b)}Variant with alternative Redox initiator
¹⁾Quickstick on polyethylene
²⁾Peel strength on steel
³⁾Shear strength atmospheric conditions (23° C.; 50% relative atmospheric humidity)
⁴⁾Shear strength at 70° C.
⁵⁾Heat resistance S.A.F.T.
⁶⁾ No testing possible since non-sticky

TABLE 9
application results of different hybrid dispersions with in each case pure polyethylene
acrylate in the acrylic fraction (Fox Tg = −8° C.); variation of ratio
PU/PA, acid number of the PUD, and neutralizing agent and degree of neutralization.

| | | Quickstick¹⁾ | Peel strength²⁾ | Shear | Shear | |
|---|---|---|---|---|---|---|
| | | [N/25 mm] | [N/25 mm] | strength³⁾ | strength⁴⁾ | |
| Hybrid | PUD, | (fracture | (fracture | [h] (fracture | [h] (fracture | S.A.F.T.⁵⁾ |
| dispersion | amount | pattern) | pattern) | pattern) | pattern) | [° C.] |
| 16 | PUD-1, 30% | 1.6 (A) | 14.9 (A) | 5.9 | 0.5 | 172 |
| 5 | PUD-1, 50% | 1.5 (A) | 15.6 (A) | >100 | >100 | 170 |
| 17 | PUD-1, 70% | 0.7 (A) | 20.9 (A) | 42.2 | 14.7 | 162 |
| 18 | PUD-2, 50% | 1.0 (A) | 19.0 (A) | >100 | 069 | 168 |
| 19 | PUD-3, 30% | 1.4 (A) | 15.8 (A) | 10.9 | 100 | >180 |
| 20 | PUD-3, 50% | 0.9 (A) | 22.8 (A) | 100 | 100 | >180 |
| 21 | PUD-3, 70% | 0.7 (A) | 22.8 (A) | 34.9 | 1.1 | 176 |
| 22 | PUD-4, 40% | 1.3 (A) | 17.6 (A) | 55.3 | 100 | 176 |
| 23 | PUD-4, 50% | 0.1 (A) | 14.2 (A) | 73.5 | 28.8 | 143 |

TABLE 10
application results of different hybrid dispersions in “batch
method” (PPG-based PUD, PU/PA = 50:50).

| | | Quickstick¹⁾ | Peel strength²⁾ | Shear | | Shear | |
|---|---|---|---|---|---|---|---|
| | | [N/25 mm] | [N/25 mm] | strength³⁾ | | strength⁴⁾ | |
| Hybrid | Fox Tg | (fracture | (fracture | [h] (fracture | | [h] (fracture | S.A.F.T.⁵⁾ |
| dispersion | [° C.] | pattern) | pattern) | pattern) | | pattern) | [° C.] |
| C24 | −42 | 4.3 (A) | 42.9 (K) | 0.05 | (K) | 0.02 (K) | 035 |
| C25 | −18 | 0.7 (A) | 17.6 (A) | 1.9 | (K) | 0.2 (K) | 115 |
| C26 | −8 | 3.0 (A) | 22.0 (A) | 3.0 | (K) | 0.1 (K) | 098 |
| C27 | +13 | 0.6 (A) | 20.8 (A) | 7 | (K) | 0.5 (K) | 127 |

¹⁾Quickstick on polyethylene
²⁾Peel strength on steel
³⁾Shear strength atmospheric conditions (23° C.; 50% relative atmospheric humidity)
⁴⁾Shear strength at 70° C.
⁵⁾Heat resistance S.A.F.T.
⁶⁾ No testing possible since non-sticky

TABLE 11
application results of different hybrid dispersions (PU/PA =
50:50) with variation of the polyol component of the PUD.

| | | | Quickstick¹⁾ | | Peel strength²⁾ | | Shear | | Shear | | |
|---|---|---|---|---|---|---|---|---|---|---|---|
| | | | [N/25 mm] | | [N/25 mm] | | strength³⁾ | | strength⁴⁾ | | |
| Hybrid | Fox T_{g} | Polyol | (fracture | | (fracture | | [h] (fracture | | [h] (fracture | | S.A.F.T. ⁵⁾ |
| dispersion | [° C.] | component | pattern) | | pattern) | | pattern) | | pattern) | | [° C.] |
| 2 | −42 | Polyether | 0.9 | (A) | 11.0 | (A) | >100 | | >100 | | 168 |
| 5 | −8 | (PPG) | 1.5 | (A) | 15.6 | (A) | >100 | | >100 | | 170 |
| C28 | −42 | aliphat. | 12.2 | (A) | 11.4 | (K) | 0.05 | (K) | 0.01 | (K) | 47 |
| C29 | −8 | polyester | 14.2 | (Z) | 17.8 | (K) | 0.03 | (K) | 0.03 | (K) | 36 |
| C30 | −42 | aromat. | 1.3 | (A) | 19 | (A) | 1.1 | (F) | 0.1/(K*) | | 80 |
| C31 | −8 | polyester | 0.9 | (A) | 10.4 | (A) | 4 | (F) | 0.08 | (K*) | 68 |
| C32 | −42 | Polyester | 1.7 | (A) | 16 | (A) | 5.2 | (F) | 0.1 | (K) | 86 |
| C33 | −8 | with dim. FA | 1.6 | (A) | 26.7 | (A) | 2.2 | (F) | 0.1 | (K) | 71 |
| C34 | −42 | aliphat. poly- | 0.2 | (A) | 3.9 | (A) | >100 | | 0.08 | (A) | 120 |
| C35 | −8 | carbonate | 0.6 | (A) | 7.4 | (A) | 30.7 | (F) | 0.3 | (F) | 116 |

¹⁾Quickstick on polyethylene
²⁾Peel strength on steel
³⁾Shear strength atmospheric conditions (23° C.; 50% relative atmospheric humidity)
⁴⁾Shear strength at 70° C.
⁵⁾ Heat resistance S.A.F.T.
⁶⁾ No testing possible since non-sticky

TABLE 12
application results of different hybrid dispersions (PU/PA =
50:50) with variation of the molar mass of the PUD

| | | | Quickstick¹⁾ | | Peel strength²⁾ | | Shear | | Shear | | |
|---|---|---|---|---|---|---|---|---|---|---|---|
| | | Molar | [N/25 mm] | | [N/25 mm] | | strength³⁾ | | strength⁴⁾ | | |
| Hybrid | Fox T_{g} | mass | (fracture | | (fracture | | [h] (fracture | | [h] (fracture | | S.A.F.T. ⁵⁾ |
| dispersion | [° C.] | PUD | pattern) | | pattern) | | pattern) | | pattern) | | [° C.] |
| 2 | −42 | Average | 0.9 | (A) | 11.0 | (A) | >100 | | >100 | | 168 |
| 5 | −8 | | 1.5 | (A) | 15.6 | (A) | >100 | | >100 | | 170 |
| C36 | −42 | Low | 26.0 | (Z) | 12 | (K) | <0.02 | (K) | <0.02 | (K) | 33 |
| C37 | −8 | | 24.2 | (Z) | 14.6 | (K) | <0.02 | (K) | <0.02 | (K) | 33 |
| C38 | −42 | Low | 01.2 | (A) | 13.0 | (A) | 1.2 | (K) | 0.08 | (K) | 84 |
| C39 | −8 | | 1.1 | (A) | 13.2 | (A) | 2.4 | (A0) | 0.1 | (K) | 76 |
| C40 | −42 | high/ | 0.2 | (A) | 0.4 | (F) | 0.1 | (A) | 2.2 | (A) | >100 |
| C41 | −8 | cross- | 0.1 | (A) | 2.8 | (A) | 0.1 | (A) | >100 | | >100 |
| | | linked | | | | | | | | | |
| C42 | −42 | high/ | <0.1 | (A) | <0.1 | (A) | | | | | |
| C43 | −8 | cross- | <0.1 | (A) | <0.1 | (A) | | | | | |
| | | linked | | | | | | | | | |

¹⁾Quickstick on polyethylene
²⁾Peel strength on steel
³⁾Shear strength atmospheric conditions (23° C.; 50% relative atmospheric humidity)
⁴⁾Shear strength at 70° C.
⁵⁾ Heat resistance S.A.F.T.
⁶⁾ No testing possible since non-sticky

1: An aqueous polymer dispersion obtained by a process comprising:
A) forming an aqueous dispersion of at least one essentially uncrosslinked polyurethane PU in the form of dispersed polyurethane particles,
where the polyurethane PU is obtained by a polymerization of polyurethane-forming compounds PU-M, comprising at least one diol PU-M2, which has at least one poly-C₂-C₁₄-alkylene ether group which has at least one unit of the formula (i):
—O—CHR^{a}—CH₂—R^{b}— (i),
where
R^{a} is hydrogen or C₁-C₁₂-alkyl,
R^{b} is a bond or C₁-C₃-alkylene,
where R^{a} is not hydrogen if R^{b} is a bond,
and where the PU has essentially no ethylenically unsaturated double bonds and has a gel fraction of <20%; and
B) radical polymerization of a monomer composition PA-M from radically polymerizable, ethylenically unsaturated compounds, comprising, as main constituent, at least one monomeric ethylenically unsaturated compound which has a solubility in water of <60 g/l at 20° C. and 1 bar, where the monomer composition has a theoretical glass transition temperature according to Fox of at most 50° C., in the aqueous dispersion of the at least one polyurethane PU, where the majority of the monomer composition PA-M is added in the course of the polymerization to the aqueous dispersion of the at least one polyurethane PU.

2: The aqueous polymer dispersion according to claim 1, wherein the polyurethane PU is obtained by a polymerization of polyurethane-forming compounds PU-M, consisting to at least 98% by weight of:
a) at least one isocyanate compound PU-M1, comprising:
a1) at least one diisocyanate compound PU-M1a and
a2) optionally at least one isocyanate compound PU-M1b, different from PU-M1a, which has more than 2 isocyanate groups per molecule,
b) at least one di- or polyol component, comprising:
b1) at least one diol PU-M2 which has at least one poly-C₂-C₁₄-alkylene ether group which has at least one unit of the formula (i)
—O—CHR^{a}—CH₂—R^{b}— (i),
where
R^{a} is hydrogen or C₁-C₁₂-alkyl,
R^{b} is a bond or C₁-C₃-alkylene,
where R^{a} is not hydrogen if R^{b} is a bond, and
b2) optionally one or more diol or polyol components PU-M3, different from PU-M2, which are selected from
aliphatic saturated oligomeric and polymeric diol and polyol compounds PU-M3a and
aliphatic, cycloaliphatic and aromatic low molecular weight diol compounds PU-M3b with a molar mass of less than 400 g/mol,
c) optionally at least one component PU-M4 which has at least one polar group and at least one group that is reactive towards isocyanate,
d) optionally one or more component PU-M5, different from the components a) to c), which has at least one group that is reactive towards isocyanate.

3: The aqueous polymer dispersion according to claim 2, wherein the polyurethane-forming compounds PU-M comprise:
a) 5 to 40% by weight of at least one isocyanate component PU-M1, based on the total mass of the compounds PU-M,
b1) 45 to 100% by weight based on the total mass of the compounds PU-M2, PU-M3, PU-M4 and PU-M5, of at least one diol component PU-M2,
b2) 0 to 20% by weight based on the total mass of the compounds PU-M2, PU-M3, PU-M4 and PU-M5, of at least one diol or polyol component PU-M3,
c) 0 to 15% by weight based on the total mass of the compounds PU-M2, PU-M3, PU-M4, PU-M5, of at least one component PU-M4, and
d) 0 to 10% by weight based on the sum of the compounds PU-M2, PU-M3, PU-M4, PU-M5, of compounds PU-M5 different from the components a) to c).

4: The aqueous polymer dispersion according to claim 1, wherein the isocyanate component PU-M1 comprises, as main constituent, at least one diisocyanate compound PU-M1a which is selected from diisocyanate compounds having 4 to 60 carbon atoms.

5: The aqueous polymer dispersion according to claim 1, wherein the isocyanate component PU-M1 comprises, as main constituent, at least one diisocyanate compound PU-M1a which is selected from toluene 2,4-diisocyanate (TDI), 1-isocyanato-3,5,5-trimethyl-5-isocyanatomethylcyclohexane (isophorone diisocyanate, IPDI), tetramethylxylylene diisocyanate (TMXDI), hexamethylene diisocyanate (HDI), bis(4-isocyanatocyclohexyl)methane (HMDI) and mixtures thereof.

6: The aqueous polymer dispersion according to claim 1, wherein the diol PU-M2 has at least one poly-C₂-C₁₄-alkylene ether group which has at least one unit of the formula (i)
—O—CHR^{a}—CH₂—R^{b}— (i),
where
R^{a} is C₁-C₁₂-alkyl,
R^{b} is a bond or C₁-C₃-alkylene.

7: The aqueous polymer dispersion according to claim 1, wherein the diols PU M2 are selected from poly-C₂-C₁₄-alkylethylene ether diols which have at least 80% by weight, based on the total weight of the diol, of units of the formula (i).

8: The aqueous polymer dispersion according to claim 1, wherein the compounds PU-M3a are selected from the group consisting of aliphatic polyether diols, polyether polyols, polyester diols, polyester polyols, polycarbonate diols and polycarbonate polyols different from PU-M2.

9: The aqueous polymer dispersion according to claim 1, wherein the compounds PU-M3b are selected from the group consisting of unbranched and branched C₂-C₁₀-alkanediols and C₂-C₁₀-alkanediols.

10: The aqueous polymer dispersion according to claim 1, wherein the compounds PU M4 are compounds which have one or more NCO-reactive groups, which are selected from the group consisting of hydroxy, thiol, primary amine and secondary amine and have at least one polar group which is selected from the group consisting of salts of carboxylic acids, sulfonic acids, sulfuric acid, sulfuric acid half-esters, phosphoric acids, phosphoric acid half-esters and phosphonic acids or polyethylene oxide and polyethylene oxide copolymers.

11: The aqueous polymer dispersion according to claim 1, wherein the polyurethane PU has less than 0.1 mol/kg of ethylenically unsaturated bonds.

12: The aqueous polymer dispersion according to claim 1, wherein the polyurethane PU has less than 2% by weight, based on the total weight of the polyurethane, of urea groups.

13: The aqueous polymer dispersion according to claim 1, wherein the polyurethane PU has a weight-average molar mass M_{W} in the range from 10 000 to 500 000 g/mol.

14: The aqueous polymer dispersion according to claim 1, wherein the polyurethane PU is essentially gel-free.

15: The aqueous polymer dispersion according to claim 1, wherein the polyurethane PU has a degree of branching of less than 10%.

16: The aqueous polymer dispersion according to claim 1, wherein the monomer composition PA-M comprises at least 30% by weight based on the total weight of PA-M, of at least one monomer PA-M1 which is selected from the group consisting of C₁-C₂₀-alkyl esters of acrylic acid, C₁-C₂₀-alkyl esters of methacrylic acid and mixtures thereof.

17: The aqueous polymer dispersion according to claim 1, wherein the monomer composition PA-M comprises the following components:
a) 30 to 100% by weight based on the total mass of the monomer composition PA-M, of at least one monomer PA-M1;
b) 0 to 70% by weight based on the total mass of the monomer composition PA-M, of at least one monomer PA-M2, which is selected from the group consisting of vinylaromatic compounds, vinyl esters of saturated, branched and unbranched C₁-C₁₂-carboxylic acids and diunsaturated, branched and unbranched C₄-C₈-alkenes.

18: The aqueous polymer dispersion according to claim 1, wherein the theoretical glass transition temperature of the polymer which is composed of the monomer composition PA-M is at most 50° C.

19: The aqueous polymer dispersion according to claim 1, wherein the weight ratio of the polyurethane PU to the polymerized monomers PA-M ranges from 5:95 to 95:5.

20: The aqueous polymer dispersion according to claim 1, wherein the polymer particles have an average particle size, Z average measured by means of dynamic light scattering, of from 0.01 to 2.0 μm.

21: A process for preparing an aqueous polymer dispersion, the process comprising:
A) forming an aqueous dispersion of at least one essentially uncrosslinked polyurethane PU in the form of dispersed polyurethane particles,
where the polyurethane PU is obtained by a polymerization of polyurethane-forming compounds PU-M, comprising at least one diol PU-M2, which has at least one poly-C₂-C₁₄-alkylene ether group which has at least one unit of the formula (i)
—O—CHR^{a}—CH₂—R^{b}— (i),
where
R^{a} is hydrogen or C₁-C₁₂-alkyl,
R^{b} is a bond or C₁-C₃-alkylene,
where R^{a} is not hydrogen if R^{b} is a bond,
and where the PU has essentially no ethylenically unsaturated double bonds and has a gel fraction of <20%; and
B) radical polymerization of a monomer composition PA-M from radically polymerizable, ethylenically unsaturated compounds, comprising, as main constituent, at least one monomeric ethylenically unsaturated compound which has a solubility in water of <60 g/l at 20° C. and 1 bar, where the monomer composition has a theoretical glass transition temperature according to Fox of at most 50° C., in the aqueous dispersion of the at least one polyurethane PU, where the majority of the monomer composition PA-M is added in the course of the polymerization to the aqueous dispersion of the at least one polyurethane PU.

22: The process according to claim 21, wherein the reaction b) occurs such that:
B1) firstly some of the polymerization initiator and some of the monomer composition PA-M is added to the aqueous dispersion of the polyurethane PU and the polymerization is initiated, and
B2) after at least partial polymerization of the monomers of the monomer composition PA-M present in the dispersion, further monomer composition PA-M is added.

23: The process according to claim 22, wherein the addition in step B2) occurs continuously.

24: The process according to either of claim 22, wherein some of the polymerization initiator is added in step B1) and at least some of the polymerization initiator is added after step B2).

25: The process according to claim 21, wherein the polymerization of the monomer composition PA-M is carried out in the presence of a polymerization initiator which comprises at least one transition metal.

26: A pressure-sensitive adhesive, comprising the aqueous polymer dispersion of claim 1.

27: A pressure-sensitive adhesive article, comprising a substrate at least partially coated with at least one aqueous polymer dispersion of claim 1.

28: A pressure-sensitive adhesive article, comprising a substrate at least partially coated with at least one aqueous polymer dispersion obtained by the process of claim 21.
